(19) United States
(12) Patent Application Publication
(10) Pub. No.: US 2025/0083771 A1
(43) Pub. Date: Mar. 13, 2025

(54) Engine Configurations for Snowmobiles

(71) Applicant: Arctic Cat Inc., Thief River Falls, MN (US)

(72) Inventors: Guy L. Sibilleau, Roseau, MN (US); Cord Miller Christensen, Goodridge, MN (US); David L. Vigen, Thief River Falls, MN (US); Nenad Malinovic, Emmingen-Liptingen (DE)

(73) Assignee: Arctic Cat Inc., Thief River Falls, MN (US)

(21) Appl. No.: 18/751,798

(22) Filed: Jun. 24, 2024

Related U.S. Application Data
(60) Provisional application No. 63/537,179, filed on Sep. 7, 2023.

(51) Int. Cl. B62M 27/02; F01N 13/08; F02B 75/02; F02D 9/08; F02M 35/10; F02M 35/104; F02M 35/16

(52) U.S. Cl. CPC B62M 27/02; F01N 13/08; F02B 75/02; F02D 9/08; F02M 35/10026; F02M 35/10144; F02M 35/104; F02M 35/162; B62M 2027/023; F02B 2075/027

(57) ABSTRACT

A snowmobile includes a forward frame assembly defining an engine bay. An engine is positioned within the engine bay. The engine has a plurality of intake ports positioned on an aft side of the engine and a plurality of exhaust ports positioned on a forward side of the engine. An air intake system has at least one air inlet and a plurality of air outlets. The air intake system is coupled to the aft side of the engine such that each of the air outlets is configured to provide air to one of the intake ports. An exhaust system has a plurality of exhaust inlets and at least one exhaust outlet. The exhaust system is coupled to the forward side of the engine such that each of the exhaust inlets is configured to receive exhaust from one of the exhaust ports.

### CROSS-REFERENCE TO RELATED APPLICATIONS

The present application claims the benefit of U.S. Provisional Application No. 63/537,179, filed Sep. 7, 2023, the entire contents of which are incorporated by reference herein for all purposes.

### TECHNICAL FIELD OF THE DISCLOSURE

The present disclosure relates, in general, to engines for use on land vehicles and, in particular, to four-stroke engines for use on snowmobiles that include a plurality of intake ports positioned on an aft side of the engine and a plurality of exhaust ports positioned on a forward side of the engine.

### BACKGROUND

Snowmobiles are popular recreational vehicles used in snowy and icy environments. Snowmobiles may be designed for specific applications such as trail, utility, mountain, race and crossover, to name a few. Snowmobiles typically include a pair of ski assemblies coupled to the forward end of a chassis that provide for the maneuverability of the snowmobile during these various winter activities. In addition, snowmobiles typically include a ground-engaging endless drive track disposed in an aftwardly extending drive tunnel of the chassis, with the length and design of the drive track contributing to the stability, flotation, agility, responsiveness and overall performance of the snowmobile. Power is delivered to the drive track from a powertrain that is coupled to the chassis and typically includes an engine and a transmission, such as a continuously variable transmission. The engine used in conventional snowmobiles is typically a two-stroke internal combustion engine due to the compact size and efficient design of such engines. While two-stroke engines are considered to have a high power-to-weight ratio, they also tend to produce undesirable pollution due to the direct mixing of fuel and oil. Four-stroke internal combustion engines, on the other hand, have higher fuel efficiency, generate lower emissions, produce less noise and have a simplified refueling process, which not only reduces the cost and environmental impact of operations, but also enhances the enjoyment of the riding experience on snowmobiles having such engines.

### SUMMARY

In a first aspect, the present disclosure is directed to a snowmobile that has a forward frame assembly defining an engine bay. The forward frame assembly includes a nose frame assembly having a nose frame cross member positioned forward of the engine bay. An engine is positioned within the engine bay. A tunnel is coupled to the forward frame assembly and is positioned aft of the engine bay. A heat exchanger is coupled to a forward end of the tunnel. First and second aftward engine mounts couple the engine to the heat exchanger. First and second forward engine mounts couple the engine to nose frame cross member.

In some embodiments, the forward frame assembly may include a base frame assembly that is coupled to the nose frame assembly such that the engine is suspended above the base frame assembly by the aftward and forward engine mounts. In certain embodiments, the engine may be a four-stroke engine and/or the aftward tilt angle of the engine may be between five degrees and thirty degrees relative to the vertical plane such as between ten degrees and twenty degrees relative to the vertical plane. In some embodiments, each of the aftward engine mounts may include an aperture having a vibration damper disposed therein. In certain embodiments, the aftward engine mounts may damp vibration between the engine and the heat exchanger and the forward engine mounts may damp vibration between the engine and the forward frame assembly. In some embodiments, the aftward engine mounts may be above the forward engine mounts. In certain embodiments, the aftward engine mounts may be outboard of the forward engine mounts.

In some embodiments, the first aftward engine mount may have a mount axis that is substantially horizontal, the second aftward engine mount may have a mount axis that is substantially horizontal, the first forward engine mount may have a mount axis that is substantially parallel to the aftward tilt angle of the engine and the second forward engine mount may have a mount axis that is substantially parallel to the aftward tilt angle of the engine. In certain embodiments, the mount axes of the first and second aftward engine mounts may extend in a lateral direction including, for example, in a common lateral direction. In some embodiments, the mount axes of the first and second aftward engine mounts may extend substantially normal to the mount axes of the first and second forward engine mounts. In certain embodiments, first and second mounting brackets may be coupled to the heat exchanger such that the first and second aftward engine mounts may be respectively coupled to the first and second mounting brackets. In some embodiments, a driven shaft may be operatively coupled to the engine and a bearing hub may be coupled to the chassis with the bearing hub supporting a bearing assembly. In such embodiments, the driven shaft may be rotatably coupled to the bearing hub by the bearing assembly and the bearing hub may be coupled to the first aftward engine mount. Also, in such embodiments, a first mounting bracket may be coupled to the heat exchanger such that the first aftward engine mount may be coupled between the first mounting bracket and the bearing hub.

In certain embodiments, a drive track system may be at least partially disposed within the tunnel with the drive track system including a track driveshaft having an axis of rotation. In such embodiments, the first aftward engine mount may have a mount axis that is oriented in a substantially radial direction relative to the axis of rotation of the track driveshaft, the second aftward engine mount may have a mount axis that is oriented in a substantially radial direction relative to the axis of rotation of the track driveshaft, the first forward engine mount may have a mount axis that is substantially parallel to the aftward tilt angle of the engine and the second forward engine mount may have a mount axis that is substantially parallel to the aftward tilt angle of the engine. In some embodiments, the heat exchanger may include an engine mounting system positioned on a forward wall of the heat exchanger with the aftward engine mounts coupled to the engine mounting system. In certain embodiments, the heat exchanger may include an engine mounting system integrally formed on the forward wall of the heat exchanger with the aftward engine mounts coupled to the engine mounting system. In some embodiments, the heat exchanger may include mounting rails positioned on the forward wall of the heat exchanger with the aftward engine mounts coupled to the mounting rails. In certain embodiments, the heat exchanger may include mounting rails integrally formed on the forward wall of the heat exchanger with the aftward engine mounts coupled to the mounting rails. In some embodiments, the mounting rails may include first and second recessed mounting locations configured to respectively receive the first and second aftward engine mounts therein. In certain embodiments, each of the first and second aftward engine mounts may include a mounting flange such that the mounting flanges of the first and second aftward engine mounts are respectively received in the first and second recessed mounting locations. In some embodiments, the mounting rails may include upper and lower slots, the mounting flange of the first aftward engine mount may be coupled to first recessed mounting location using first upper and lower bolts that are respectively secured within the upper and lower slots and the mounting flange of the second aftward engine mount may be coupled to second recessed mounting location using second upper and lower bolts that are respectively secured within the upper and lower slots.

In a second aspect, the present disclosure is directed to a snowmobile that has a forward frame assembly defining an engine bay. The forward frame assembly includes a nose frame assembly having a nose frame cross member positioned forward of the engine bay. An engine is positioned within the engine bay and has an aftward tilt angle relative to a vertical plane. A tunnel is coupled to the forward frame assembly and is positioned aft of the engine bay. A drive track system is positioned at least partially within the tunnel. The drive track system includes a track driveshaft having an axis of rotation. A heat exchanger is coupled to a forward end of the tunnel. The heat exchanger includes an engine mounting system positioned on a forward wall of the heat exchanger, such as mounting rails integrally formed on a forward wall of the heat exchanger. First and second forward engine mounts couple the engine to nose frame cross member. First and second aftward engine mounts couple the engine to the engine mounting system. Each of the aftward engine mounts has a mount axis that is oriented in a substantially radial direction relative to the axis of rotation of the track driveshaft.

In a third aspect, the present disclosure is directed to a forward frame assembly for a snowmobile. The forward frame assembly includes a welded frame assembly that has a base frame assembly with a nose frame assembly that is welded thereto. A first side frame assembly is welded to the base frame assembly and the nose frame assembly. The first side frame assembly includes a first forward spar. A fixed portion of a second side frame assembly is welded to the base frame assembly and the nose frame assembly. A steering column mount is welded between the first side frame assembly and the fixed portion of the second side frame assembly. The forward frame assembly also has a separable portion of the second side frame assembly that is couplable to the fixed portion of the second side frame assembly with non-permanent fasteners. The separable portion of the second side frame assembly includes a second forward spar.

In certain embodiments, the base frame assembly may include first and second base beams and a base cross member welded to the first and second base beams. In some embodiments, the nose frame assembly may include first, second and third nose trusses, a nose frame cross member welded to the first and second nose trusses and a nose rail welded to each of the first, second and third nose trusses. In such embodiments, each of the first, second and third nose trusses may be welded to the base frame assembly. In certain embodiments, the first side frame assembly may include a first joint welded to the first forward spar, a first upper beam welded to the first joint, a first aft spar welded to the first upper beam and a first plate member welded to the first aft spar. In such embodiments, the first joint may be welded to the nose frame assembly and the first plate member may be welded to the base frame assembly. In some embodiments, the fixed portion of the second side frame assembly may include a top flange, a second joint having an upper flange and an aft flange, a second aft spar and a second plate member that is welded to the second aft spar and has an upper flange. In such embodiments, the top flange and the second aft spar may be welded to the steering column mount, the second joint may be welded to the nose frame assembly and/or the second plate member may be welded to the base frame assembly.

In certain embodiments, the separable portion of the second side frame assembly may include a second upper beam that is couplable to the aft flange of the second joint and to the upper flange of the second plate member with non-permanent fasteners and the second forward spar may be couplable to the upper flange of the second joint and to the top flange with non-permanent fasteners. In some embodiments, an upper cross member may be welded to the second forward spar and the first forward spar may include a lateral flange. In such embodiments, the upper cross member may be couplable to the lateral flange of the first forward spar with a non-permanent fastener. In certain embodiments, each of the first forward spar and the second forward spar may be a bent spar such that the first forward spar and the second forward spar are bent in a forward direction to provide engine clearance.

In a fourth aspect, the present disclosure is directed to a snowmobile having a chassis that includes a forward frame assembly coupled to a tunnel. A heat exchanger is coupled to a forward end of the tunnel such that the forward frame assembly and the heat exchanger defining an engine bay. An engine is positioned within the engine bay and is coupled to the forward frame assembly and the heat exchanger. The forward frame assembly includes a welded frame assembly that has a base frame assembly with a nose frame assembly that is welded thereto. A first side frame assembly is welded to the base frame assembly and the nose frame assembly. The first side frame assembly includes a first forward spar. A fixed portion of a second side frame assembly is welded to the base frame assembly and the nose frame assembly. A steering column mount is welded between the first side frame assembly and the fixed portion of the second side frame assembly. The forward frame assembly also includes a separable portion of the second side frame assembly that is couplable to the fixed portion of the second side frame assembly with non-permanent fasteners. The separable portion of the second side frame assembly includes a second forward spar.

In some embodiments, the first side frame assembly may include a first plate member and the fixed portion of the second side frame assembly may include second plate member. In such embodiments, the heat exchanger may be coupled between the first and second plate members. In certain embodiments, the nose frame assembly may include a nose frame cross member. In such embodiments, the engine may be coupled between the nose frame cross member and the heat exchanger.

In a fifth aspect, the present disclosure is directed to a method for assembling a snowmobile. The method includes providing a welded frame assembly including a base frame assembly, a nose frame assembly welded to the base frame assembly, the nose frame assembly including a nose frame cross member, a first side frame assembly welded to the base frame assembly and the nose frame assembly, the first side frame assembly including a first forward spar, a fixed portion of a second side frame assembly welded to the base frame assembly and the nose frame assembly and a steering column mount welded between the first side frame assembly and the fixed portion of the second side frame assembly; forming an engine bay by coupling a heat exchanger to the first side frame assembly and the fixed portion of the second side frame assembly; suspending an engine within the engine bay above the base frame assembly by coupling the engine to the nose frame cross member and the heat exchanger; and coupling a separable portion of the second side frame assembly to the fixed portion of the second side frame assembly with non-permanent fasteners, the separable portion of the second side frame assembly including a second forward spar.

In some embodiments, the method may include providing a base frame assembly having first and second base beams and a base cross member welded to the first and second base beams; providing a nose frame assembly having first, second and third nose trusses, the nose frame cross member welded to the first and second nose trusses, a nose rail welded to each of the first, second and third nose trusses with each of the first, second and third nose trusses welded to the base frame assembly; and/or providing a first side frame assembly having a first joint welded to the first forward spar, a first upper beam welded to the first joint, a first aft spar welded to the first upper beam and a first plate member welded to the first aft spar, with the first joint welded to the nose frame assembly and the first plate member welded to the base frame assembly.

In certain embodiments, the method may include providing a fixed portion of the second side frame assembly having a top flange, a second joint having an upper flange and an aft flange, a second aft spar and a second plate member welded to the second aft spar and having an upper flange with the top flange and the second aft spar welded to the steering column mount, the second joint welded to the nose frame assembly and the second plate member welded to the base frame assembly; coupling the second forward spar to the upper flange of the second joint and to the top flange with the non-permanent fasteners; coupling a second upper beam to the aft flange of the second joint and to the upper flange of the second plate member with the non-permanent fasteners; and/or coupling an upper cross member that is welded to the second forward spar to a lateral flange of the first forward spar with the non-permanent fastener.

In some embodiments, the method may include having a fluid conduit coupled to a forward side of the heat exchanger. In certain embodiments, the method may include having first and second engine mounting brackets on a forward side of the heat exchanger or having engine mounting rails on the forward side of the heat exchanger. In some embodiments, the method may include laterally inserting the engine into the welded frame assembly through a window in the fixed portion of the second side frame assembly; shifting the engine forward relative to the welded frame assembly; and lowering the engine onto the nose frame cross member. In certain embodiments, the method may include coupling two forward engine mounts to the nose frame cross member and coupling at least one aft engine mount to the heat exchanger. In other embodiments, the method may include coupling two forward engine mounts to the nose frame cross member and coupling two aft engine mounts to the heat exchanger. In certain embodiments, the method may include inserting studs of two forward engine mounts through openings of the nose frame cross member as the engine is lowered relative to the welded frame assembly.

In some embodiments, the method may include having an exhaust manifold and an air runner assembly coupled to the engine prior to inserting the engine into the welded frame assembly. In such embodiments, the method may include coupling an air plenum to the air runner assembly after suspending the engine within the engine bay and before coupling the separable portion of the second side frame assembly to the fixed portion of the second side frame assembly; coupling an airbox to the first and second forward spars; and coupling an air duct between the airbox and the air plenum with the air duct routed forward of and outboard of the second forward spar. In certain embodiments, the method may include having an exhaust manifold, an air runner assembly and an air plenum coupled to the engine prior to inserting the engine into the welded frame assembly. In some embodiments, the method may include positioning the engine within the engine bay with an aftward tilt angle relative to a vertical plane and with forward and aft engine mounts located above a crankshaft of the engine.

In a sixth aspect, the present disclosure is directed to a snowmobile having a forward frame assembly that defines an engine bay. An engine is positioned within the engine bay. The engine has a plurality of intake ports positioned on an aft side of the engine and a plurality of exhaust ports positioned on a forward side of the engine. An air intake system has at least one air inlet and a plurality of air outlets. The air intake system is coupled to the aft side of the engine such that each of the air outlets is configured to provide air to one of the intake ports. An exhaust system has a plurality of exhaust inlets and at least one exhaust outlet. The exhaust system is coupled to the forward side of the engine such that each of the exhaust inlets is configured to receive exhaust from one of the exhaust ports.

In certain embodiments, the engine may be a four-stroke engine. In some embodiments, the air intake system may include an airbox positioned at least partially forward of the engine bay. The airbox may include the at least one air inlet which may be positioned outboard of the engine bay. In certain embodiments, the air intake system may include an air plenum that is positioned on top of the engine. In some embodiments, the air plenum may be positioned at least partially within the engine bay. In certain embodiments, the air intake may include a throttle valve assembly coupled to the air plenum. The throttle valve assembly may be positioned outboard of the engine bay and/or below the at least one air inlet. In some embodiments, the air intake system may include an air duct coupled between the airbox and the throttle valve assembly that is routed forward and outboard of the forward frame assembly. In certain embodiments, the air intake system may include an air runner assembly coupled between the air plenum and the aft side of the engine. The air runner assembly may include the plurality of air outlets and may extends aftward and downward from the air plenum. In some embodiments, the exhaust system may include an exhaust manifold coupled to the forward side of the engine. The exhaust manifold may include the exhaust inlets. In certain embodiments, the exhaust system may include a muffler positioned outboard of the engine bay. In some embodiments, the air intake system may include a throttle valve assembly positioned outboard of the engine bay on a first side of the engine and the exhaust system may include a muffler positioned outboard of the engine bay on a second side of the engine that is opposite the first side of the engine.

In a seventh aspect, the present disclosure is directed to a snowmobile including a forward frame assembly that defines an engine bay. An engine is positioned within the engine bay. The engine has a plurality of intake ports positioned on an aft side of the engine and a plurality of exhaust ports positioned on a forward side of the engine. An air intake system is coupled to the aft side of the engine. The air intake system includes an airbox having an air inlet that is positioned outboard of the engine bay, an air plenum positioned on top of the engine, a throttle valve assembly coupled between the airbox and the air plenum, the throttle valve assembly positioned outboard of the engine bay on a first side of the engine and an air runner assembly coupled between the air plenum and the engine, the air runner assembly including a plurality of air outlets each of which is configured to provide air to one of the intake ports. An exhaust system is coupled to the forward side of the engine. The exhaust system includes an exhaust manifold having a plurality of exhaust inlets each of which is configured to receive exhaust from one of the exhaust ports and a muffler including an exhaust outlet positioned outboard of the engine bay on a second side of the engine that is opposite of the first side. Each of the engine, the air plenum, the air runner assembly and the exhaust manifold is at least partially disposed within the engine bay.

In certain embodiments, the throttle valve assembly may be positioned below the air inlet. In some embodiments, the air runner assembly may extend aftward and downward from the air plenum. In certain embodiments, the engine may be tilted aftward such that an upper portion of the engine is aft of a lower portion of the engine. In some embodiments, a heat exchanger may be coupled to the forward frame assembly forward of the engine. In such embodiments, the heat exchanger may be tilted forward such that an upper portion of the heat exchanger is forward of a lower portion of the heat exchanger. In certain embodiments, at least a portion of the exhaust manifold may be positioned between the heat exchanger and the engine. In some embodiments, the muffler may be positioned aft of the heat exchanger.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIGS. 1A-1E are schematic illustrations of a snowmobile in accordance with embodiments of the present disclosure;

FIGS. 2A-2E are schematic illustrations of various systems for a snowmobile in accordance with embodiments of the present disclosure;

FIGS. 3A-3G are schematic illustrations of an engine for a snowmobile in accordance with embodiments of the present disclosure;

FIGS. 4A-4B are isometric views of an air intake system and an exhaust system for a snowmobile in accordance with embodiments of the present disclosure;

FIGS. 5A-5I are schematic illustrations of sequential steps for assembling a snowmobile in accordance with embodiments of the present disclosure;

FIGS. 6A-6C are schematic illustrations of an engine mounting system for a snowmobile in accordance with embodiments of the present disclosure; and

FIGS. 7A-7C are schematic illustrations of an engine mounting system for a snowmobile in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the devices described herein may be oriented in any desired direction. As used herein, the term “coupled” may include direct or indirect coupling by any means, including by mere contact or by moving and/or non-moving mechanical connections.

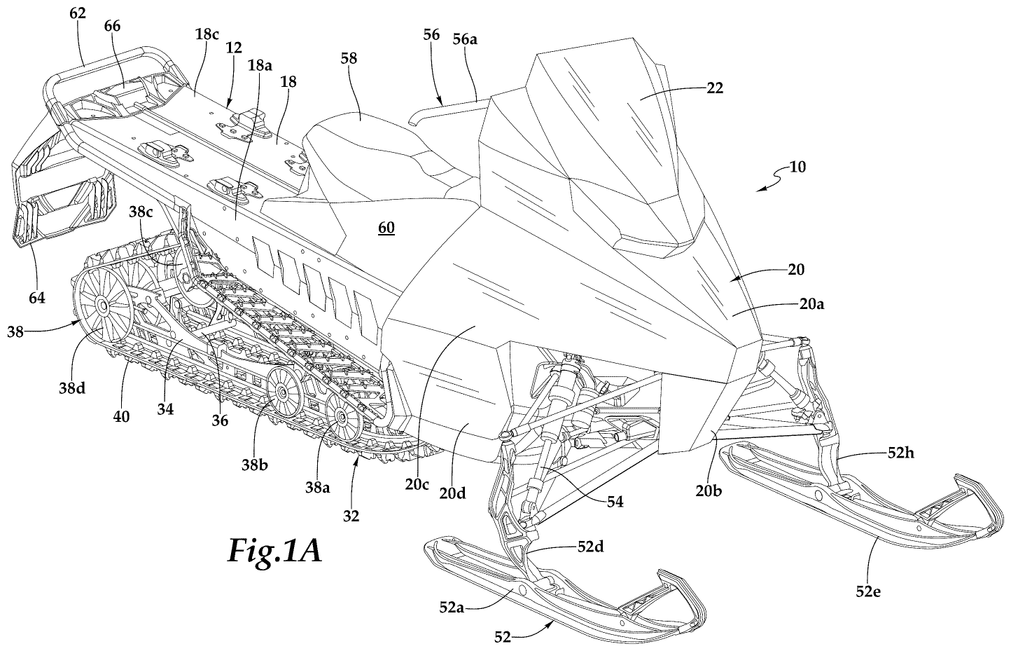

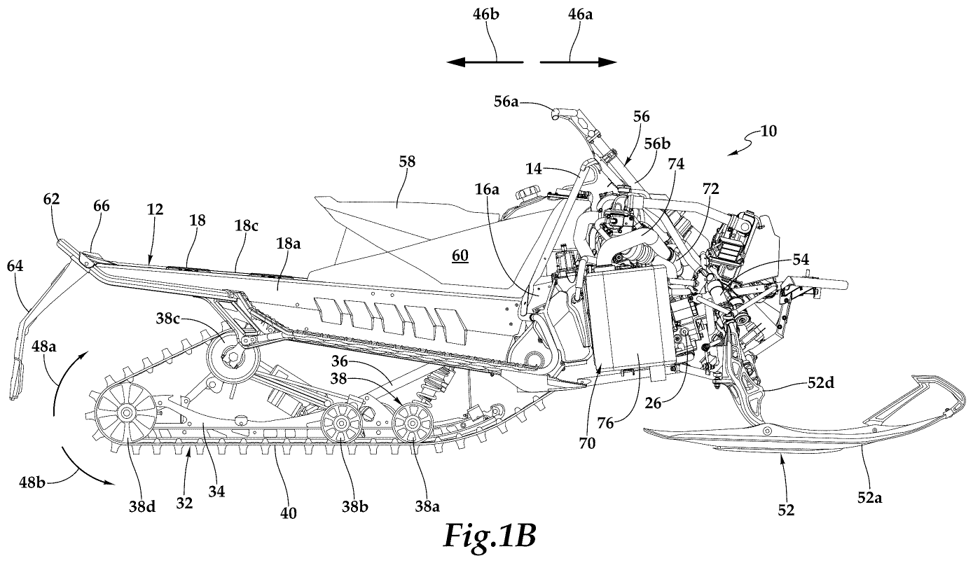

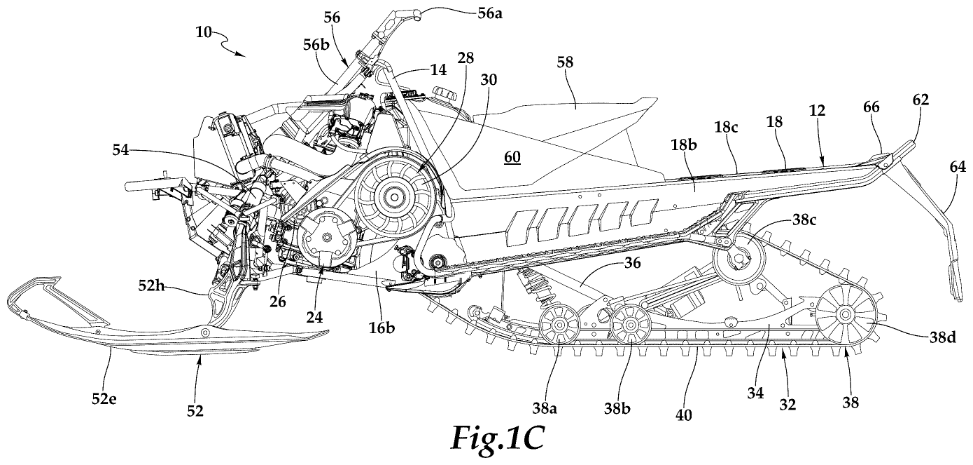

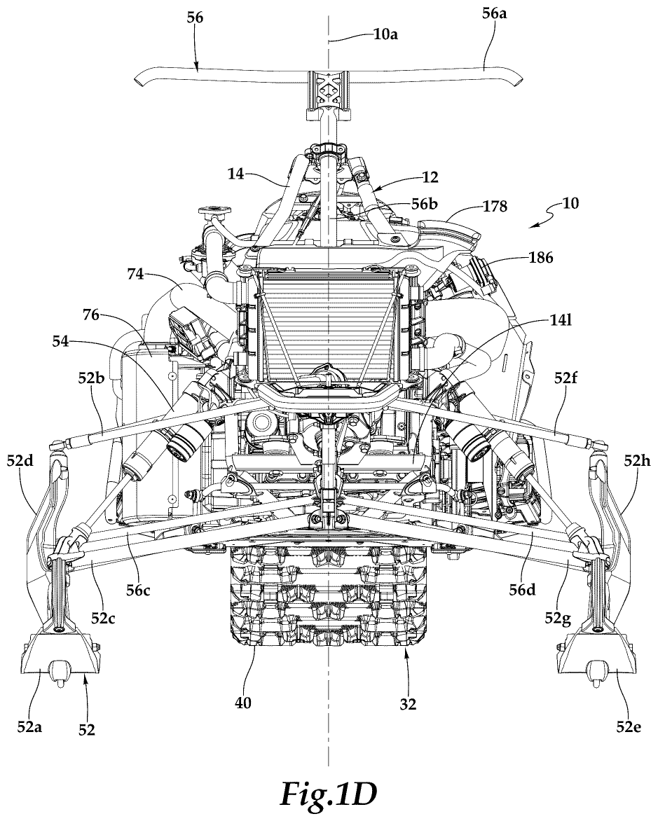

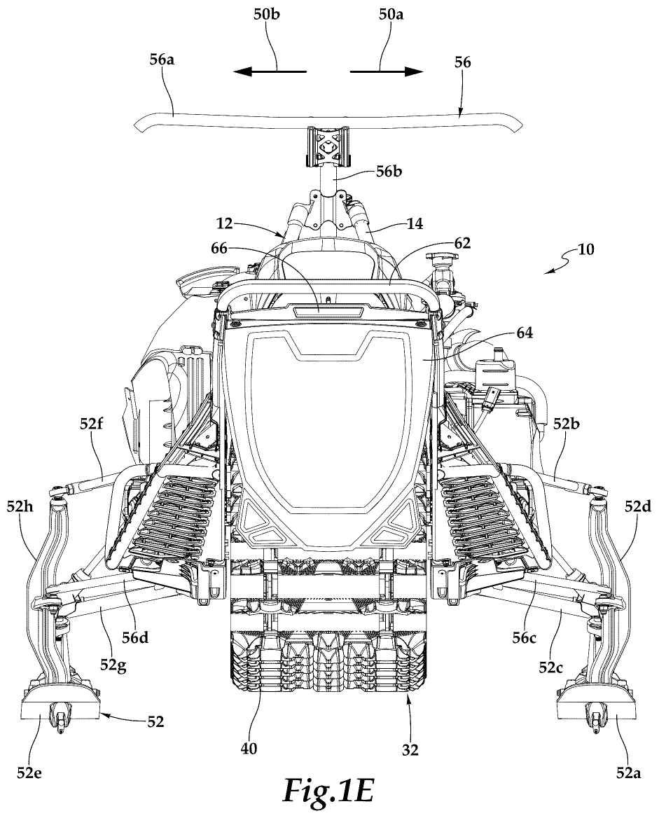

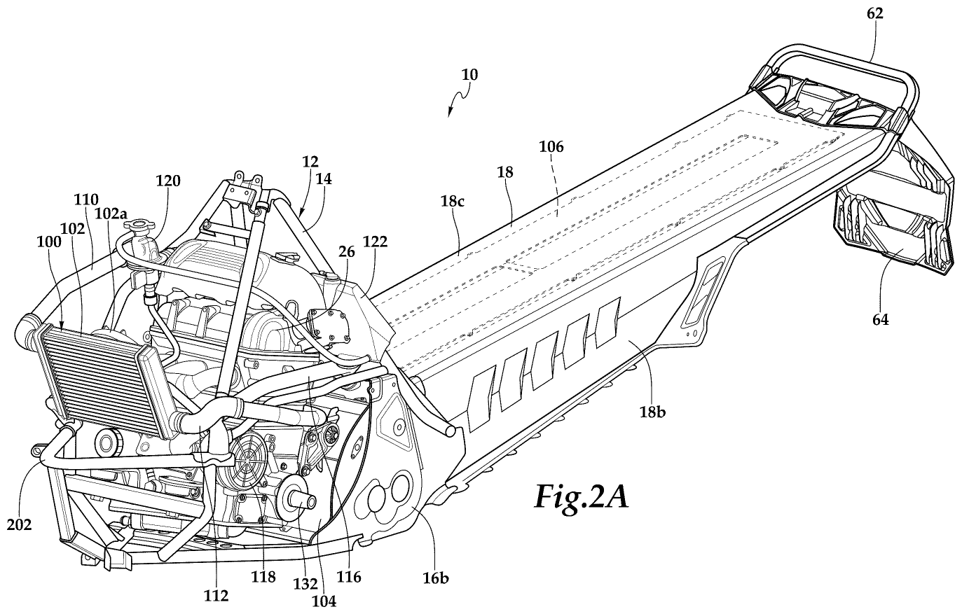

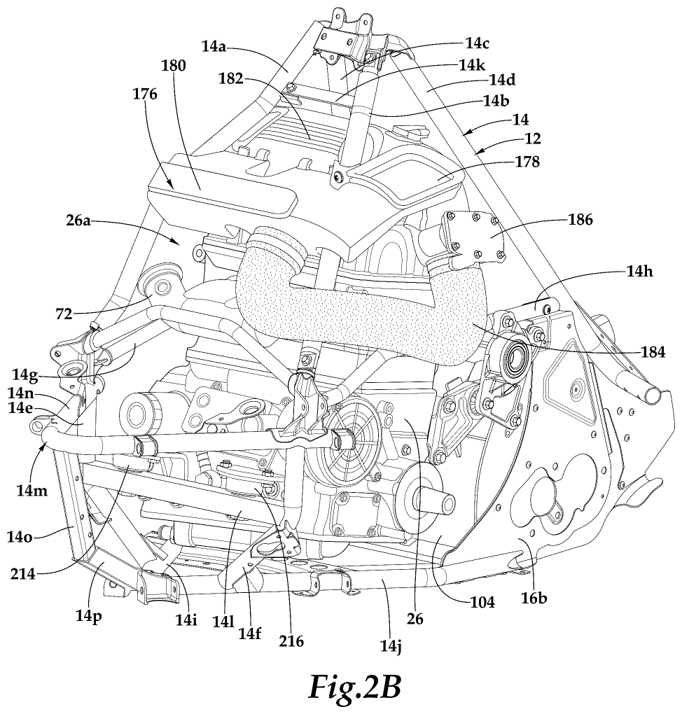

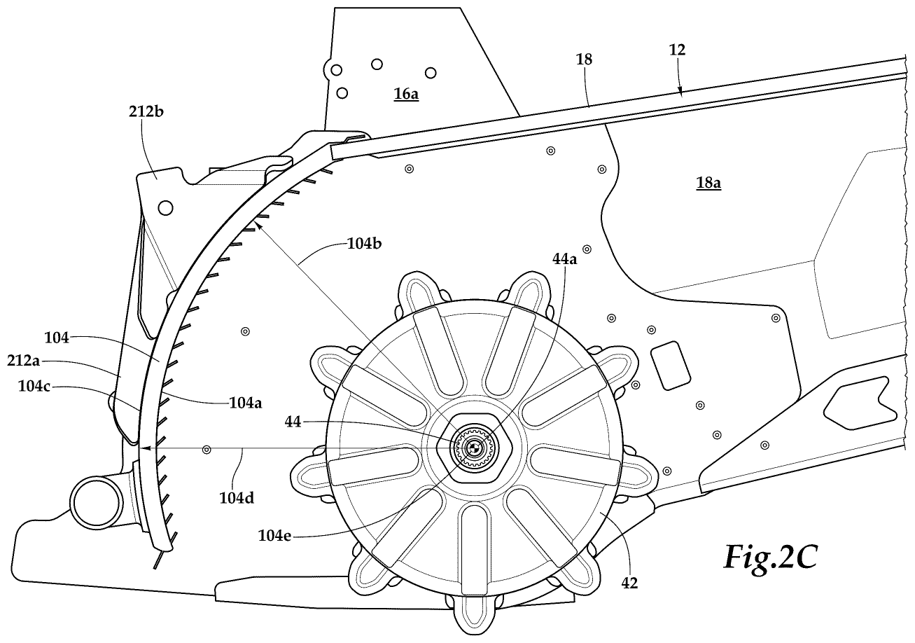

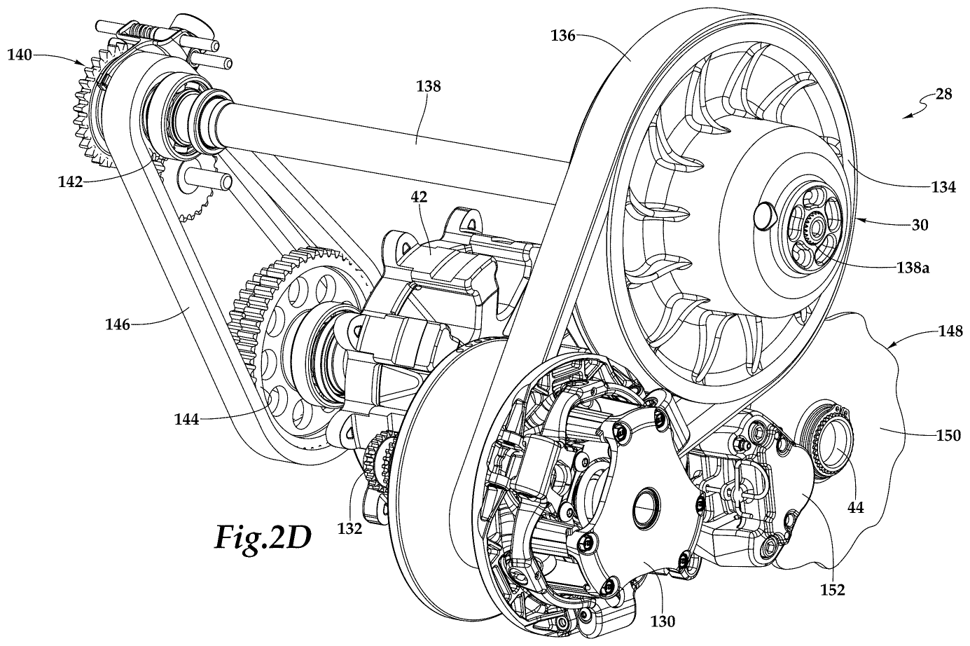

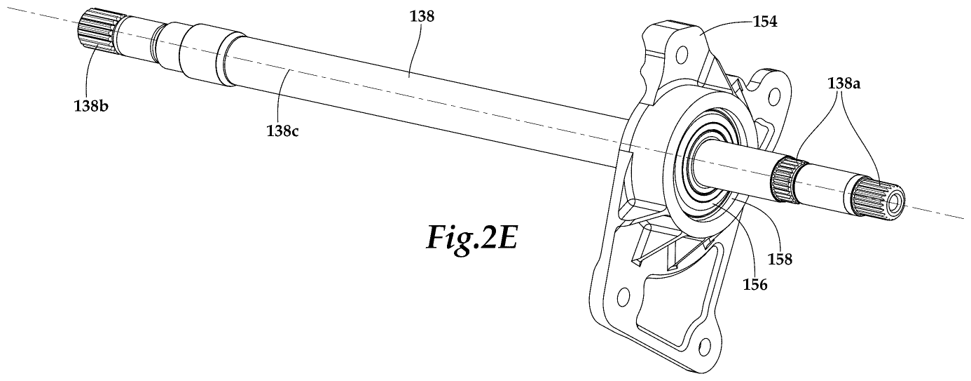

Referring to FIGS. 1A-1E in the drawings, a land vehicle depicted as a snowmobile is schematically illustrated and generally designated 10. Structural support for snowmobile 10 is provided by a chassis 12 that includes a forward frame assembly 14 and a longitudinally extending tunnel 18. Forward frame assembly 14 (see also FIG. 2B) may be formed from interconnected tubular members such as round and hollow tubular members comprised of metal, metal alloy, polymeric materials, fiber reinforced polymer composites and/or combinations thereof that are coupled together by welds, bolts, pins or other suitable fastening means. In the illustrated embodiment, forward frame assembly 14 includes a right-forward spar 14a, a left-forward spar 14b, a right-aft spar 14c, a left-aft spar 14d, a right truss 14e, a left truss 14f, a right-upper beam 14g, a left-upper beam 14h, a right-lower beam 14i, a left-lower beam 14j, an upper cross member 14k, a lower cross member 14l and a nose frame assembly 14m including a nose rail 14n and a nose truss 14o. Forward frame assembly also includes a pivot mount joint 14p that couples to and is preferably welded to right-lower beam 14i, left-lower beam 14j and nose truss 14o. Pivot mount joint 14p may be of the type disclosed in commonly owned U.S. patent application Ser. No. 18/103,879, filed Jan. 31, 2023, the entire contents of which are incorporated by reference herein for all purposes. A right side plate member 16a and a left side plate member 16b are coupled to and preferably welded to forward frame assembly 14 such that forward frame assembly 14 and plate members 16a, 16b form a welded frame assembly. Tunnel 18 is coupled to forward frame assembly 14 and/or plate members 16a, 16b with welds, bolts, rivets or other suitable means. In the illustrated embodiment, tunnel 18 includes a right side panel 18a, a left side panel 18b and a top panel 18c. Tunnel 18 may be integrally formed or may consist of multiple members that are coupled together with welds, bolts, rivets or other suitable means. Plate members 16a, 16b and tunnel 18 may be formed from sheet metal, metal alloy, fiber reinforced polymer or other suitable material or combination of materials.

Various components of snowmobile 10 are assembled on or around forward frame assembly 14. One or more body panels 20 cover and protect the various components of snowmobile 10 including parts of forward frame assembly 14. For example, a hood panel 20a, a nose panel 20b, an upper right side panel 20c and a lower right side panel 20d shield underlying componentry from the snow and terrain. Similarly, an upper left side panel and a lower left side panel (not visible) also shield underlying componentry from the snow and terrain. In the illustrated embodiment, snowmobile 10 has a windshield 22 that shields the rider of snowmobile 10 from snow, terrain and frigid air during operation. Even through snowmobile 10 has been described and depicted as including specific body panels 20, it should be understood by those having ordinary skill in the art that a snowmobile of the present disclosure may include any number of body panels in any configuration to provide the shielding functionality. In addition, it should be understood by those having ordinary skill in the art that the right side and the left side of snowmobile 10 will be with reference to a rider of snowmobile 10 with the right side of snowmobile 10 corresponding to the right side of the rider and the left side of snowmobile 10 corresponding to the left side of the rider.

Body panels 20 have been removed from snowmobile 10 in FIGS. 1B-1E to reveal the underlying components of snowmobile 10. For example, as best seen in FIG. 1C, snowmobile 10 has a powertrain 24 that includes an engine 26 and a drivetrain 28 both of which are coupled to forward frame assembly 14. Engine 26 resides in an engine bay 26a (see also FIG. 2B) formed within forward frame assembly 14. In the illustrated embodiment, engine bay 26a is defined by right-forward spar 14a, left-forward spar 14b, right-aft spar 14c, left-aft spar 14d, right truss 14e, left truss 14f, right-upper beam 14g, left-upper beam 14h, right-lower beam 14i, left-lower beam 14j and lower cross member 14l. In this position, tunnel 18 is positioned aft of engine bay 26a and lower cross member 14l is positioned forward of engine bay 26a. Engine 26 may be any type of engine such as a four-stroke engine, a two-stroke engine, an electric motor, a hybrid engine system or other prime mover. In the illustrated embodiment, engine 26 is an aftwardly tilted, three cylinder, four-stroke, internal combustion engine that is naturally aspirated. In other embodiments, engine 26 may be vertically mounted, forwardly tilted, have more or less than three cylinders, be a supercharged internal combustion engine or a turbo charged internal combustion engine. Drivetrain 28 includes a transmission 30 such as a continuously variable transmission, an electrically variable transmission or other suitable transmission type for varying the ratio of the engine output speed to the drive track input speed.

It should be noted that the engine used in conventional snowmobiles is typically a naturally aspirated two-stroke internal combustion engine due to the compact size and efficient design of such engines. While such two-stroke engines have a high power-to-weight ratio, they typically have low fuel efficiency, generate high noise levels and produce undesirable pollution due to the direct mixing of fuel and oil. Naturally aspirated four-stroke internal combustion engines, on the other hand, have higher fuel efficiency, produce less noise, generate lower emissions and have a simplified refueling process, which not only reduces the cost and environmental impact of operations, but also enhances the enjoyment of the riding experience. It has been found, however, that to produce the same power, four-stroke engines must generally be larger and heavier than two-stroke engines. Numerous design features discussed herein, such as the placement and design of the component of the air intake system, the placement and design of the components of the exhaust system and the placement and design of the components of the cooling system allow for the use of engine 26, a larger four-stroke engine, in the same package space as a smaller two-stroke engine in prior snowmobiles. Additional features may further enable an overall height reduction of engine 26 so that engine bay 26a can fit within engine bay 26a. For example, the scavenge pumps of engine 26 may be positioned upward within a cavity of the crankcase forward of the crankshaft such as the forwardly offset scavenge pumps described in commonly owned U.S. patent application Ser. No. 18/650,021, filed Apr. 29, 2024, the entire contents of which are incorporated by reference herein for all purposes. In addition, size reduction of engine 26 can be gained by machining the crankshaft to include sprockets such as the crankshaft described in commonly owned U.S. patent application Ser. No. 18/670,693, filed May 21, 2024, the entire contents of which are incorporated by reference herein for all purposes. Further, angling the valve fingers of engine 26 with respect to the intake/exhaust valves reduces the amount of material required compared to arranging the valve fingers parallel to each other such as the valve fingers described in commonly owned U.S. patent application Ser. No. 18/671,970, filed May 22, 2024, the entire contents of which are incorporated by reference herein for all purposes.

A drive track system 32 is at least partially disposed within and/or below tunnel 18 and is in contact with the ground to provide ground propulsion for snowmobile 10. Torque and rotational energy are provided to drive track system 32 from engine 26 via drivetrain 28. Drive track system 32 includes a track frame 34, an internal suspension 36, a plurality of idler wheels 38 such as idler wheels 38a, 38b, 38c, 38d and an endless track 40. Track frame 34 may be coupled to forward frame assembly 14 via a swing arm having a coil spring, a rigid strut, a torsion spring, an elastomeric member or any other suitable coupling configuration. Endless track 40 is driven by a track drive sprocket 42 via a track driveshaft 44 (see also FIGS. 2C-2D) that is rotated responsive to torque provided from powertrain 24. Endless track 40 rotates around track frame 34 and idler wheels 38 to propel snowmobile 10 in either the forward direction, as indicated by arrow 46a, or the backwards direction, as indicated by arrow 46b in FIG. 1B. When viewed from the right side of snowmobile 10, endless track 40 rotates around track frame 34 and idler wheels 38 in the clockwise direction, as indicated by arrow 48a, to propel snowmobile 10 in the forward direction 46a. Endless track 40 rotates around track frame 34 and idler wheels 38 in the counterclockwise direction, as indicated by arrow 48b, to propel snowmobile 10 in the backward direction 46b. The forward and backward directions also represent the longitudinal direction of snowmobile 10 with the lateral direction of snowmobile 10 being normal thereto and represented by the rightward direction, as indicated by arrow 50a, and the leftward direction, as indicated by arrow 50b in FIG. 1E. The backward direction may also be referred to herein as the aftward direction.

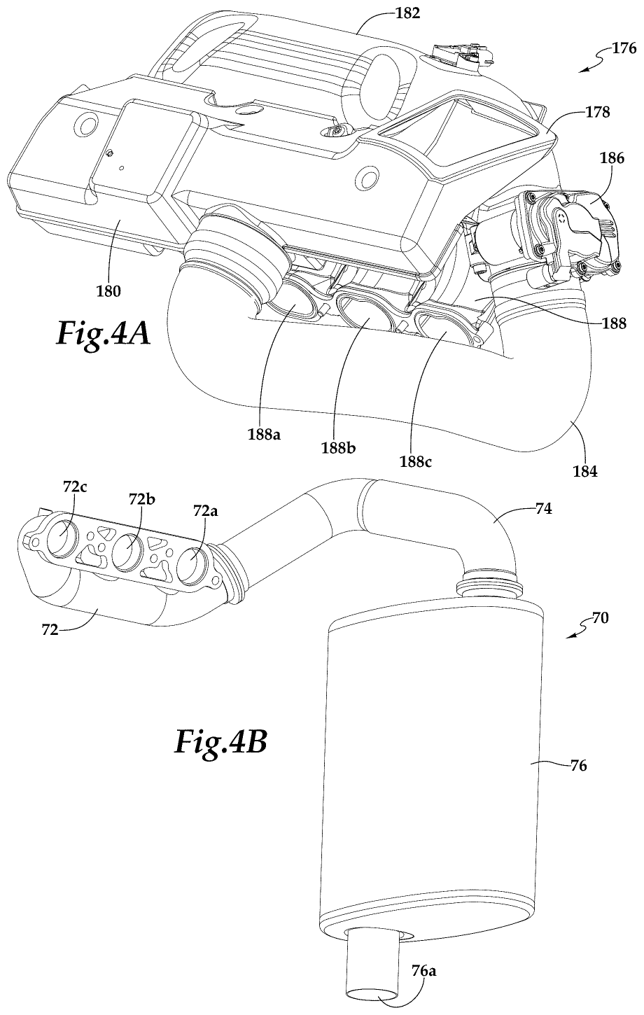

Snowmobile 10 has a ski system 52 and a front suspension assembly 54 that provide front end support for snowmobile 10. Ski system 52 includes a right ski 52a that is coupled to forward frame assembly 14 by upper and lower A-arms 52b, 52c and right spindle 52d. Ski system 52 also includes a left ski 52e that is coupled to forward frame assembly 14 by upper and lower A-arms 52f, 52g and left spindle 52h. Skis 52a, 52e are interconnected to a steering system 56 including a handlebar assembly 56a, a steering column 56b, a right tie rod 56c and a left tie rod 56d that enable the rider to steer snowmobile 10. For example, when handlebar assembly 56a is rotated, skis 52a, 52e responsively pivot to turn snowmobile 10. The rider controls snowmobile 10 from a seat 58 that is position atop a fuel tank 60, above tunnel 18, aft of handlebar assembly 56a and aft of forward frame assembly 14. Snowmobile 10 has a lift bumper 62 that is coupled to an aft end of tunnel 18 that enables a person to lift the rear end of snowmobile 10 in the event snowmobile 10 becomes stuck or needs to be repositioned when it is not moving. Snowmobile 10 has a snow flap 64 that deflects snow emitted by endless track 40. In the illustrated embodiment, snow flap 64 is coupled to lift bumper 62. In other embodiments, a snow flap may be coupled directly to tunnel 18. A taillight housing 66 is also coupled to lift bumper 62 and houses a taillight of snowmobile 10. Snowmobile 10 has an exhaust system 70 (see also FIG. 4B) that includes an exhaust manifold 72 that is coupled to the forward side of engine 26, an exhaust duct 74 and a muffler 76 that is positioned laterally and outboard of engine 26 as well as outboard of forward frame assembly 14 and engine bay 26a. Exhaust system 70 is configured to direct high-temperature exhaust gases away from engine 26 and the rider of snowmobile 10.

It should be appreciated that snowmobile 10 is merely illustrative of a variety of vehicles that can implement the embodiments disclosed herein. Other vehicle implementations can include motorcycles, snow bikes, all-terrain vehicles (ATVs), utility vehicles, recreational vehicles, scooters, automobiles, mopeds, straddle-type vehicles and the like. As such, those skilled in the art will recognize that the embodiments disclosed herein can be integrated into a variety of vehicle configurations. It should be appreciated that even though ground-based vehicles are particularly well-suited to implement the embodiments of the present disclosure, airborne vehicles and devices such as aircraft can also implement the embodiments.

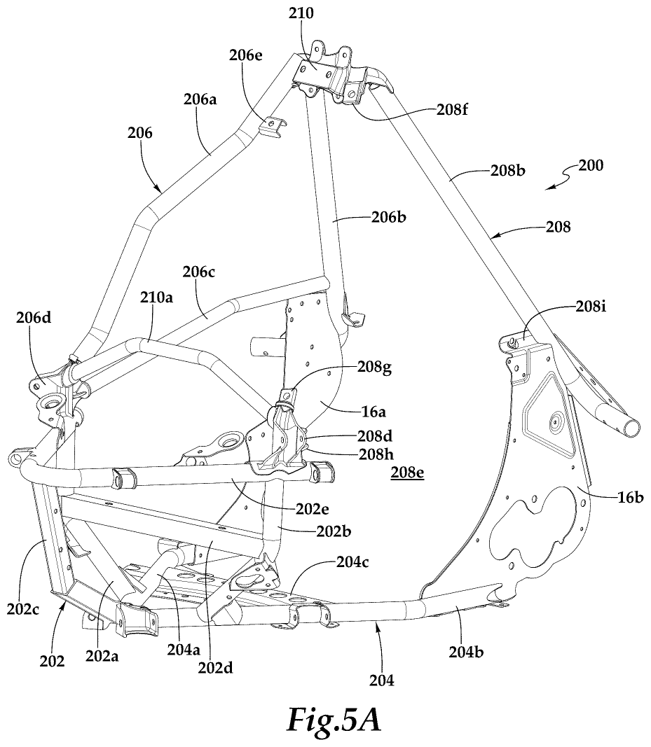

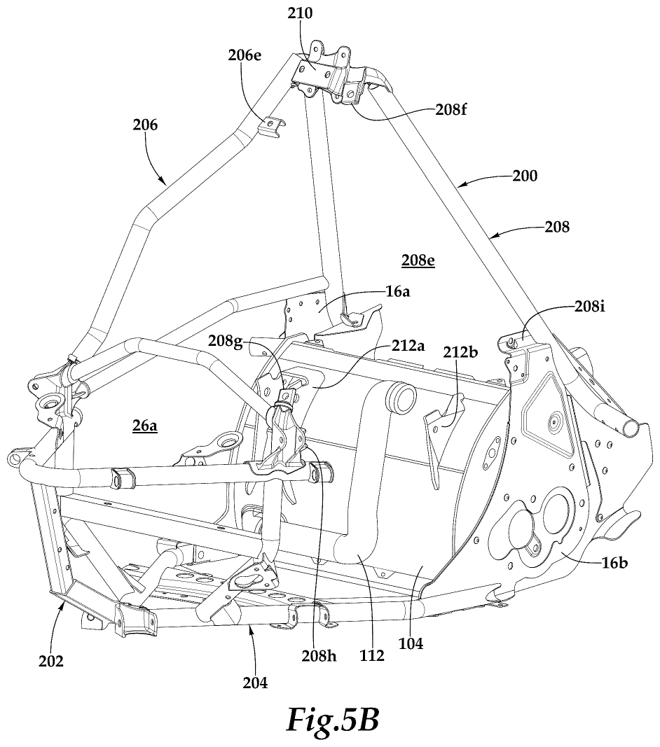

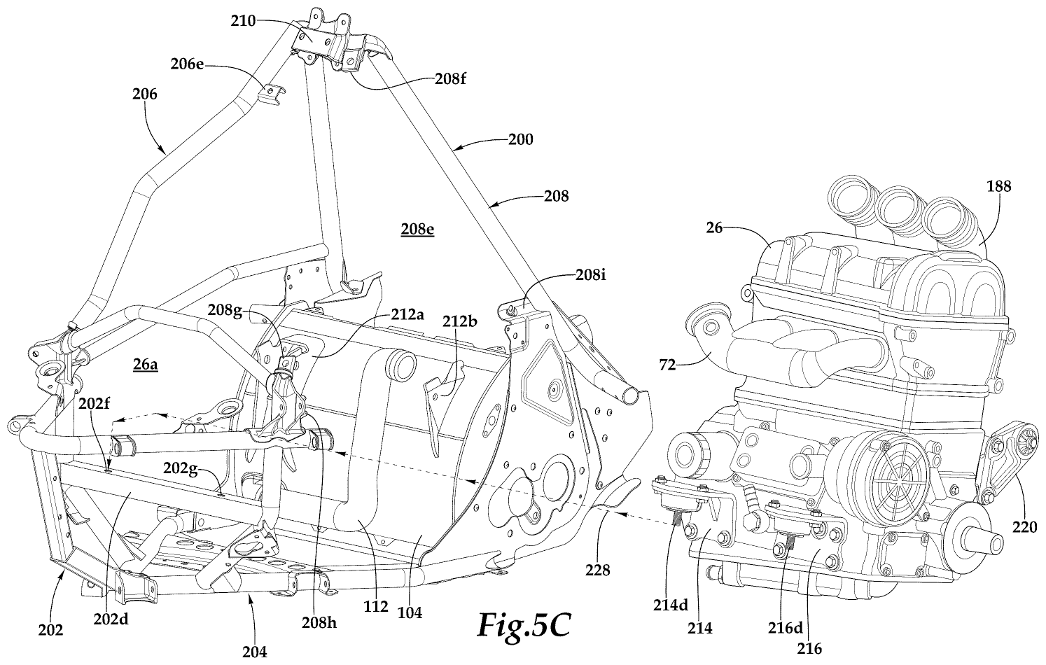

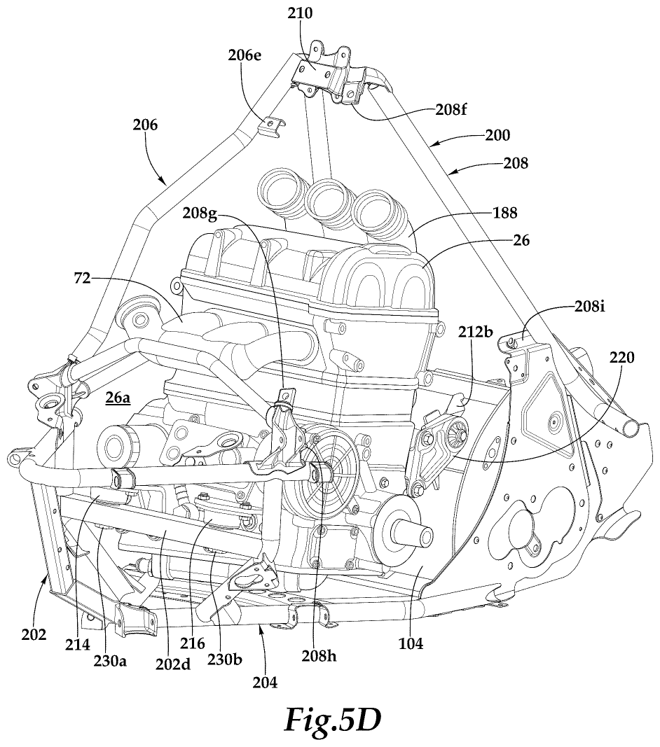

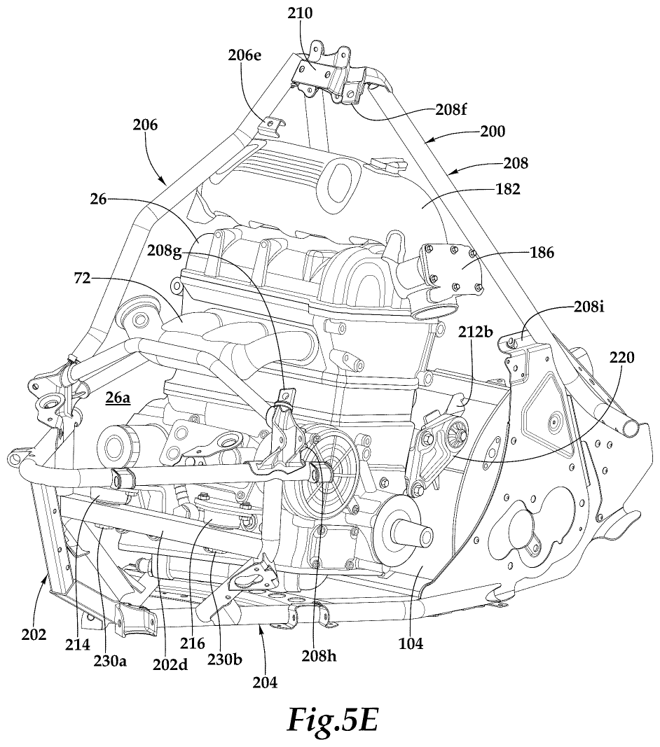

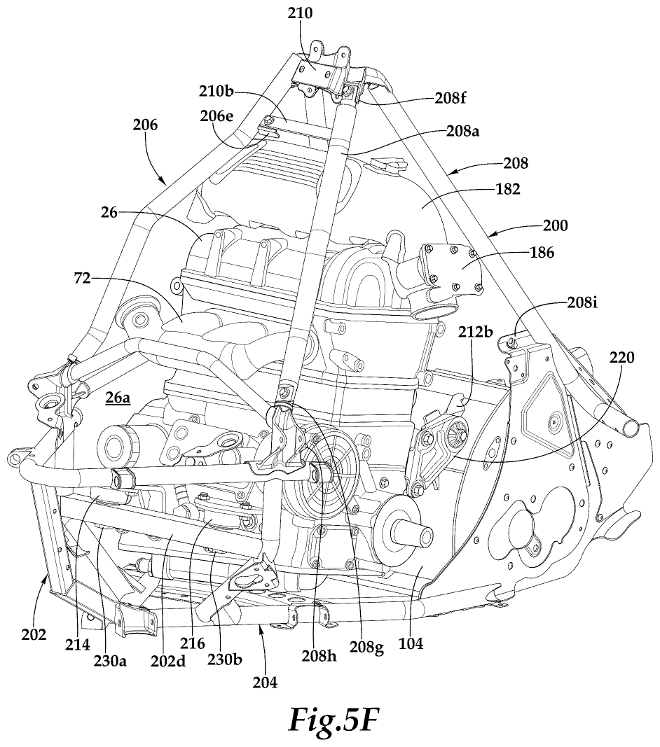

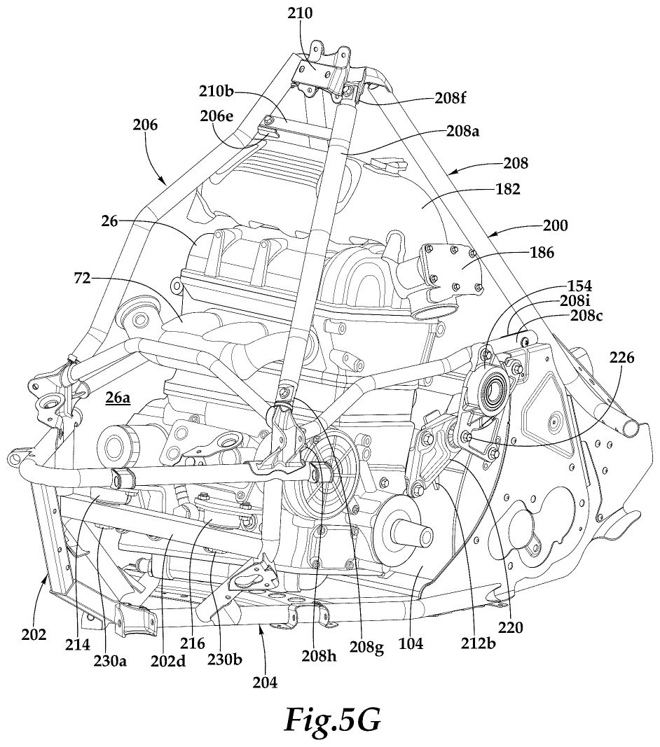

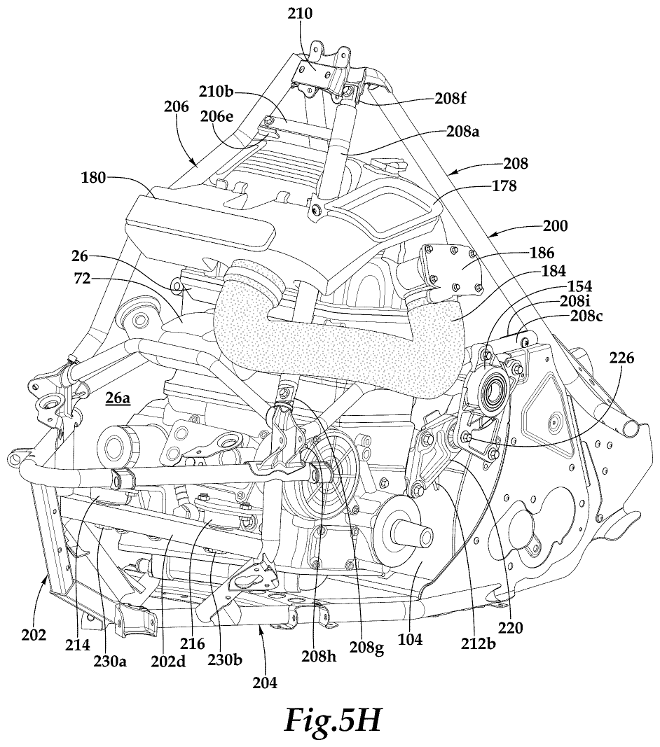

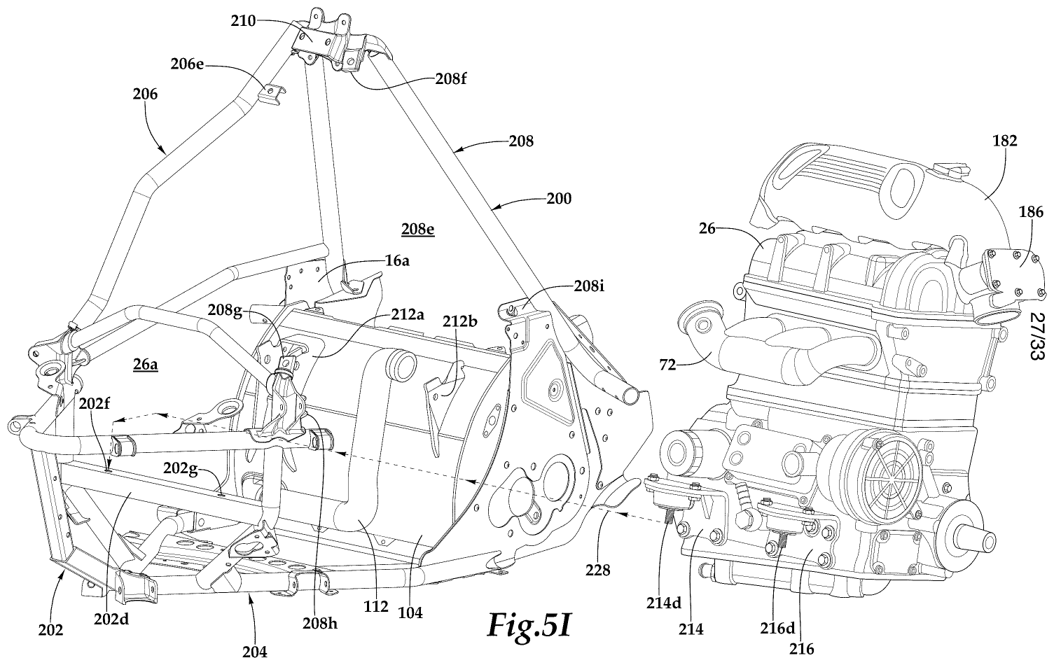

Referring additionally to FIGS. 2A-2B of the drawings, additional details regarding snowmobile 10 will now be discussed. In the illustrated embodiment, snowmobile 10 has an engine cooling system 100 that includes a forward heat exchanger depicted as a radiator 102, that is coupled to forward frame assembly 14. In other embodiments, a cooling system for a snowmobile may not include a forward heat exchanger, the forward heat exchanger may be an intercooler or the forward heat exchanger may include both a radiator and an intercooler. In the illustrated embodiment, radiator 102 is coupled to and positioned above a nose frame assembly 202 (see also FIG. 5A) of forward frame assembly 14. In this location, radiator 102 is positioned forward of engine 26 and muffler 76 and is tilted forward such that an upper portion of radiator 102 is forward of a lower portion of radiator 102. Radiator 102 is configured to remove heat from a fluid circulating therethrough responsive to air passing through radiator 102 from the front side of radiator 102 to the rear side of radiator 102. In the illustrated embodiment, radiator 102 includes a fan 102a that may be selectively operated to help air move through radiator 102. Engine cooling system 100 also includes an arcuate heat exchanger 104 that is coupled to a forward portion of tunnel 18. In this location, arcuate heat exchanger 104 is positioned aft of engine 26. Arcuate heat exchanger 104 is configured to remove heat from a fluid circulating therethrough responsive to snow in tunnel 18. For example, during operation of snowmobile 10, endless track 40 kicks snow toward an inner surface 104a of arcuate heat exchanger 104 which is configured to retain at least a portion of this snow. Heat from the fluid circulating through arcuate heat exchanger 104 is transferred to the retained snow causing the retained snow to melt.

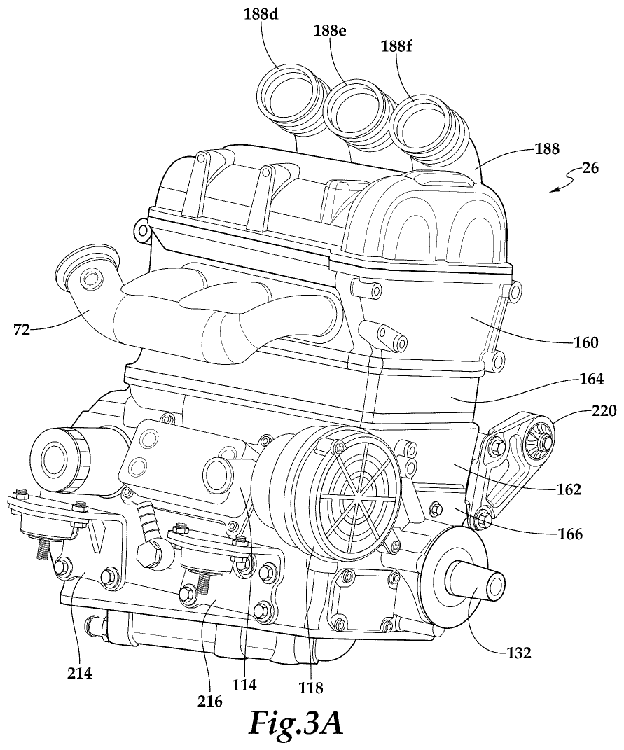

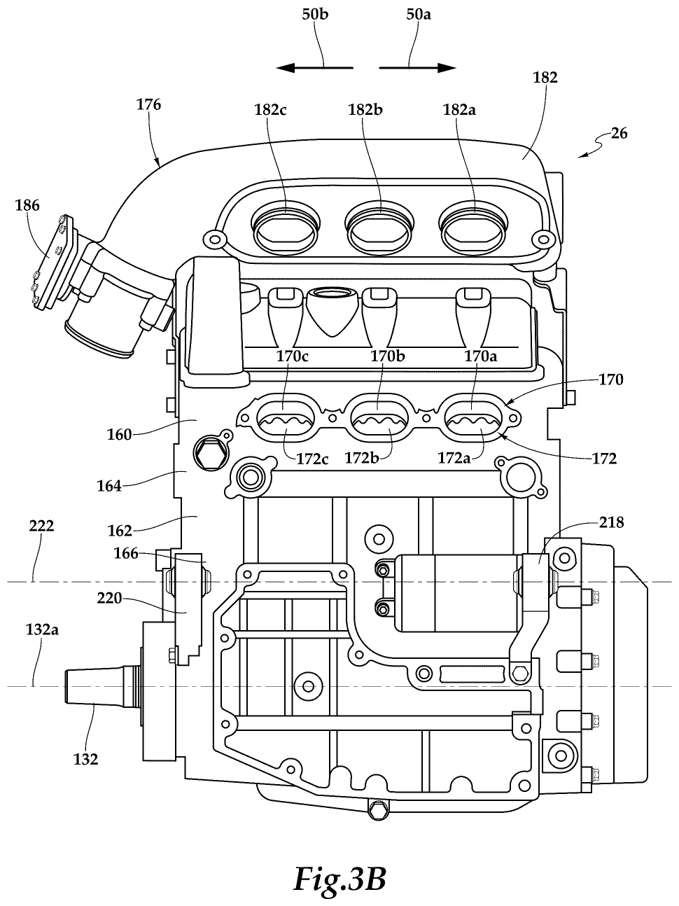

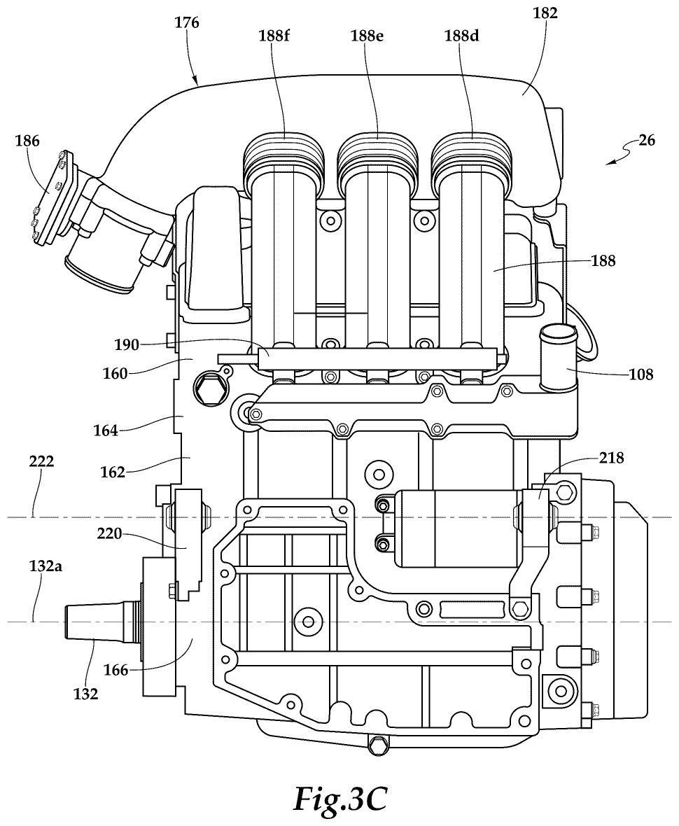

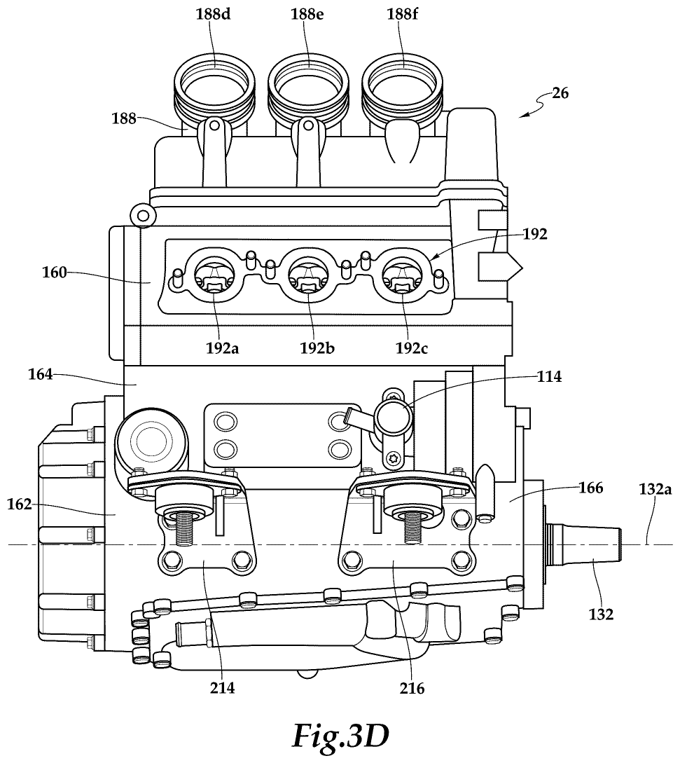

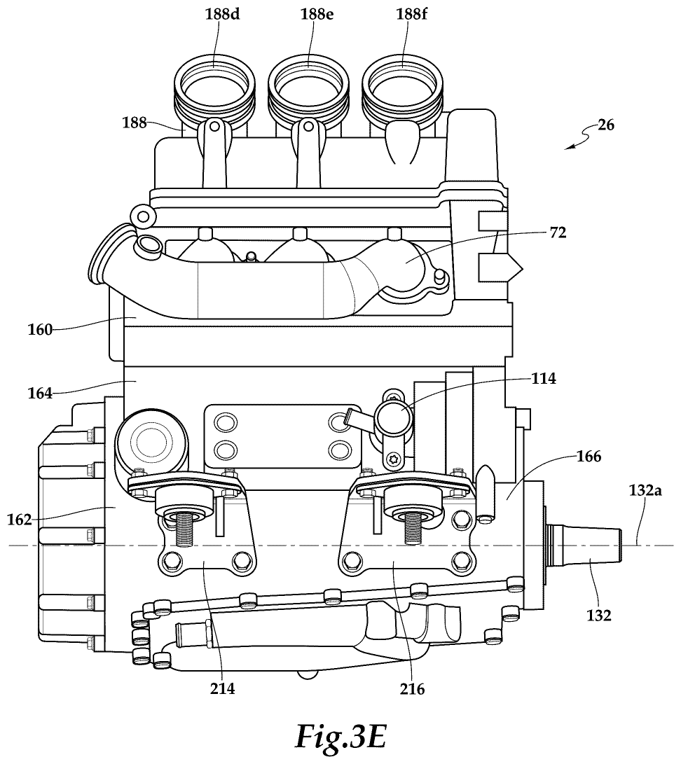

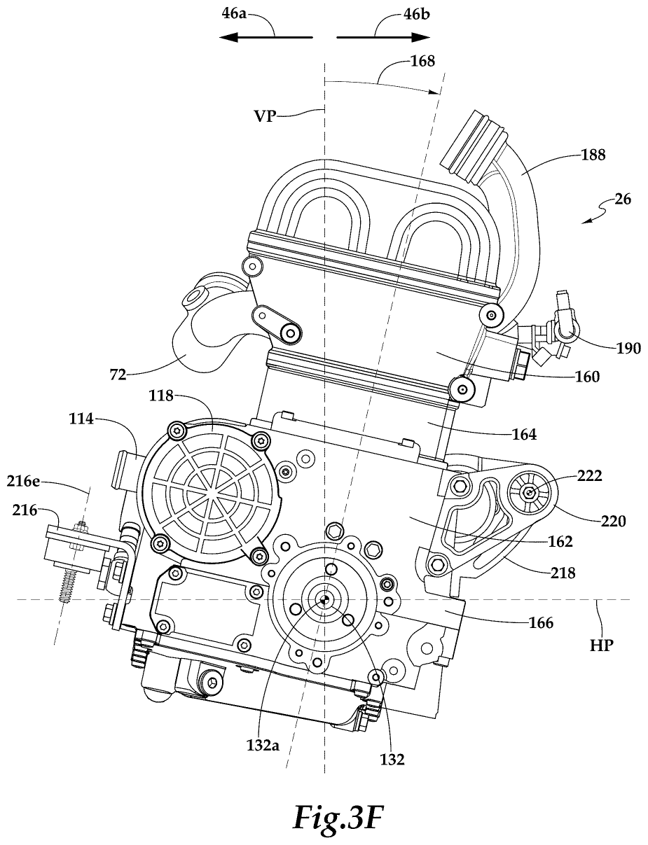

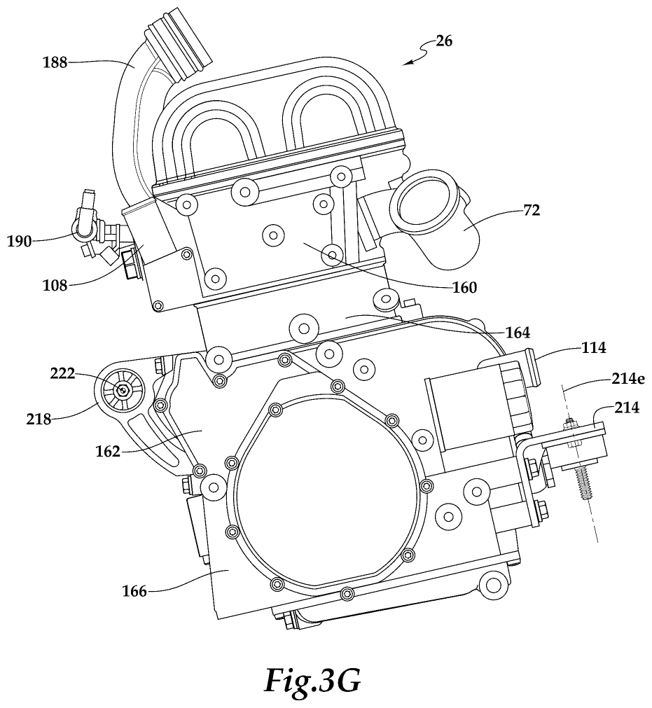

Engine cooling system 100 further includes a tunnel heat exchanger 106 that is positioned along a top portion of tunnel 18. Tunnel heat exchanger 106 is configured to remove heat from a fluid circulating therethrough responsive to snow in tunnel 18. For example, during operation of snowmobile 10, endless track 40 kicks snow toward an upper surface of tunnel 18, a portion of which sticks to this surface which is in thermal communication with tunnel heat exchanger 106. Heat from the fluid circulating through tunnel heat exchanger 106 is transferred to the retained snow causing the retained snow to melt. It is note that snow flap 64 helps to retain snow in tunnel 18 which aids in the snow sticking to the upper surface of tunnel 18. Together, radiator 102, arcuate heat exchanger 104 and tunnel heat exchanger 106 form a cooling circuit that is in fluid communication with engine 26. More specifically, radiator 102 is coupled to a fluid discharge port 108 (see also FIG. 3C) on the aftward side of engine 26 via a fluid conduit 110. Radiator 102 is also coupled to arcuate heat exchanger 104 via a fluid conduit 112. Arcuate heat exchanger 104 is coupled to tunnel heat exchanger 106 via a direct coupling (not visible). Tunnel heat exchanger 106 is coupled to a fluid inlet port 114 (see also FIGS. 3A, 3D) on the forward side of engine 26 via a fluid conduit 116. Fluid is circulated through the cooling circuit by a water pump 118 of engine 26. In the illustrated embodiment, fluid circulates through the cooling circuit sequentially from engine 26 to radiator 102 then to arcuate heat exchanger 104 then to tunnel heat exchanger 106 before returning to engine 26. Engine cooling system 100 also includes a thermostat 120 that monitors the temperature of the fluid exiting engine 26 and an expansion chamber 122 that is in fluid communication with thermostat 120.

Referring next to FIGS. 2C-2E of the drawings, drivetrain 28 will be discussed in greater detail. Drivetrain 28 includes transmission 30, depicted as a continuously variable transmission, which includes a drive pulley 130 that receives torque and rotational energy from engine 26 via engine driveshaft 132, a driven pulley 134 and a drive belt 136 that is looped around drive pulley 130 and driven pulley 134 to transfer torque from drive pulley 130 to driven pulley 134. The use of a continuously variable transmission has the advantages of continuously changing its gear ratio such that at any engine speed, the continuously variable transmission is configured to operate at peak performance. This is achieved by varying the width of drive pulley 130 and driven pulley 134 depending on the power requirement of snowmobile 10. In operation, when one of drive pulley 130 and driven pulley 134 gets larger, the other of drive pulley 130 and driven pulley 134 gets smaller. Since neither drive pulley 130, driven pulley 134 nor drive belt 136 are fixed, continuously variable transmission is configured to provide an infinite number of gear ratios.

Driven pulley 134 provides torque and rotational energy to a driven shaft 138. In the illustrated embodiment, driven shaft 138 includes multiple splined sections including input splines 138a and output splines 138b. Input splines 138a are in mesh with splines within driven pulley 134 such that operation of transmission 30 rotates driven shaft 138. Output splines 138b are in mesh with splines within drive assembly 140 that is depicted as a reduction drive assembly that is shiftable been a forward mode and a reverse mode which determines the direction 48a or 48b (see also FIG. 1B) that endless track 40 rotates around track frame 34 and idler wheels 38 and thus the direction 46a or 46b of travel of snowmobile 10. Drive assembly 140 includes a drive pulley 142 that receives torque and rotational energy from driven shaft 138, a driven pulley 144 and a drive belt 146 that is looped around drive pulley 142 and driven pulley 144 to transfer torque from drive pulley 142 to driven pulley 144. Driven pulley 144 provides torque and rotational energy to track driveshaft 44 that has a splined coupling with track drive sprocket 42 that drives endless track 40 around track frame 34 and idler wheels 38 to propel snowmobile 10. Track driveshaft 44 also has a splined coupling with a disc-and-caliper braking system 148 that includes a brake disc 150 and a brake caliper 152 used to provide a stopping force for snowmobile 10. Driven shaft 138 has an axis of rotation 138c and is received within a driven shaft bearing hub 154 that is rigidly coupled to chassis 12 and/or heat exchanger 104 (see also FIG. 5G). Driven shaft 138 is rotatably coupled to bearing hub 154 via a bearing assembly 156, such as a ball bearing assembly, which is received within a bearing aperture 158 of bearing hub 154. Bearing hub 154 rigidly supports driven shaft 138 allowing driven shaft 138 to transfer torque and rotational energy from transmission 30 to drive assembly 140. In other embodiments, support for driven shaft 138 may be provided by a torque control link that also maintains a stable center to center distance between the drive pulley and the driven pulley of the continuously variable transmission such as the torque control link described in commonly owned U.S. Patent Application 63/612,191, filed Dec. 19, 2023, the entire contents of which are incorporated by reference herein for all purposes.

Referring now to FIGS. 3A-3G of the drawings, engine 26 and various components of the air intake system and the exhaust system will now be discussed. Engine 26 is an internal combustion engine that converts thermal energy into mechanical energy to drive the moving parts snowmobile 10, thereby enabling motion. Engine 26 has a cylinder head 160 and an engine block 162 that includes a cylinder block 164 and a crankcase 166 which houses crankshaft 132 having an axis of rotation 132a. As best seen in FIG. 3F, when engine 26 is installed within snowmobile 10, engine 26 has an aftward tilt angle relative to a vertical plane VP, as indicated by arrow 168, when snowmobile 10 is resting on a horizontal surface, as illustrated in FIGS. 1B-1C. In the illustrated embodiment, the aftward tilted angle is between five degrees and thirty degrees relative to vertical plane VP such as between ten degrees and twenty degrees relative to vertical plane VP. It should be understood by those having ordinary skill in the art that engine 26 could have other aftward tilted angles both less than five degrees and greater than thirty degrees relative to vertical plane VP. As best seen in FIG. 3B, the aft side of engine 26 include a plurality of intake ports 170 through which an air and fuel mixture enters engine 26. More specifically, engine 26 includes a right intake port 170a that supplies the air and fuel mixture to a right cylinder 172a, a center intake port 170b that supplies the air and fuel mixture to a center cylinder 172b and a left intake port 170c that supplies the air and fuel mixture to a left cylinder 172c.

Referring additionally to FIG. 4A of the drawings, engine 26 has an air intake system 176 that receives air from the atmosphere and distributes the air to cylinders 172 of engine 26. More specifically, air intake system 176 includes an air inlet 178 that is positioned outboard of forward frame assembly 14 (see also FIG. 5H) that feeds air into an airbox 180 that is positioned generally forward and generally above engine 26. Air from airbox 114 is routed to an air plenum 182 via an air duct 184. Air plenum 182 is positioned on top of engine 26. The volume of air delivered to air plenum 182 from airbox 180 is controlled via a throttle valve assembly 186 that is positioned outboard of forward frame assembly 14. Throttle valve assembly 186 includes a valve such as a butterfly valve that opens and closes to control the movement of air therethrough in response to operation of the throttle input by the driver. In the illustrated embodiment, an electronic throttle control is used in which an engine control unit communicates throttle commands to throttle valve assembly 186, with the engine control unit controlling or modulating the throttle signal based on a set of operational parameters. In addition to throttle control, the engine control unit controls a variety of other engine operations including fuel delivery to engine 26.

Air plenum 182 is configured to damp the air flow prior to distribution to cylinders 172 via an air runner assembly 188. Air runner assembly 188 include the air outlets of air intake system 176; namely, right air outlet 188a, center air outlet 188b and left air outlet 188c. As best seen by comparison of FIG. 3B and FIG. 3C, air runner assembly 188 is coupled between air plenum 182 and engine 26. In the illustrated embodiment, air runner assembly 188 is coupled to each of air discharge ports 182a, 182b, 182c of air plenum 182 via air inlet ports 188d, 188e, 188f of air runner assembly 188. Air runner assembly 188 is coupled to engine 26 such that right air outlet 188a is aligned with right intake port 170a, center air outlet 188b is aligned with center intake port 170b and left air outlet 188c is aligned with left intake port 170c. Fuel for engine 26 is supplied from fuel tank 60 via a fuel rail 190 that is coupled to air runner assembly 188 and includes a multi-point fuel injector system that is configured to inject fuel into each of cylinder 172a, 172b, 172c of engine 26 respectively through right air outlet 188a, center air outlet 188b and left air outlet 188c of air runner assembly 188. Positioning fuel rail 190 between engine 26 and fuel tank 60 provides compact packaging for engine 26 as further described in commonly owned U.S. patent application Ser. No. 18/751,013, filed Jun. 21, 2024, the entire contents of which are incorporated by reference herein for all purposes.

As best seen in FIG. 3D, the forward side of engine 26 include a plurality of exhaust ports 192 through which high-temperature exhaust gases produced by the combustion of the air and fuel mixture are expelled. More specifically, engine 26 includes a right exhaust port 192a, a center exhaust port 192b and a left exhaust port 192c. Referring additionally to FIG. 4B of the drawings, engine 26 has an exhaust system 70 that includes an exhaust manifold 72 that is in fluid communication with a muffler 76 via exhaust duct 74. Muffler 76 including an exhaust outlet 76a. Exhaust system 70 is configured to direct high-temperature exhaust gases away from engine 26 and the rider of snowmobile 10. As best seen by comparison of FIG. 3D and FIG. 3E, exhaust manifold 72 is coupled to engine 26 such that exhaust inlets 72a, 72b, 72c are aligned with exhaust ports 192a, 192b, 192c. In the illustrated embodiment, exhaust manifold 72 that is coupled to the forward side of engine 26, which is the hot side of engine 26 due to the hot temperatures associated with engine exhaust. The aft side of engine 26 is concomitantly considered the cool side of engine 26 as hot exhaust system components are located opposite and/or remote therefrom.

Referring now to FIGS. 5A-5I of the drawings, aspects of forward frame assembly 14 and assembly methods for a snowmobile will now be discussed. In FIG. 5A, a welded frame assembly 200 is depicted that includes a plurality of tubular frame members and plate members that are welded together to form a single assembly weldment. Producing welded frame assembly 200 increases the efficiency of manufacturing snowmobiles by enabling large subassemblies to be preassembled and by reducing the number of parts such as fastener needed for assembly. In addition, welded frame assembly 200 may be used as a major subassembly in numerous snowmobile models, for example, welded frame assembly 200 may be used in certain snowmobiles designed for mountain operations and in certain snowmobiles designed for high performance operation. In the illustrated embodiment, welded frame assembly 200 includes nose frame assembly 202, a base frame assembly 204, a right side frame assembly 206 and a fixed portion of a left side frame assembly 208 as well as a steering column mount 210. Nose frame assembly 202 is welded to base frame assembly 204. Right side frame assembly 206 is welded to base frame assembly 204 and nose frame assembly 202. The fixed portion of left side frame assembly 208 is welded to base frame assembly 204 and nose frame assembly 202. Steering column mount 210 is welded between right side frame assembly 206 and the fixed portion of left side frame assembly 208.

In the illustrated embodiment, base frame assembly 204 include a right base frame beam 204a, a left base frame beam 204b and a base frame cross member 204c that is welded between right and left base frame beams 204a, 204b. Nose frame assembly 202 includes a right nose truss 202a, a left nose truss 202b, a center nose truss 202c, a nose frame cross member 202d and a nose rail 202e. Right nose truss 202a is welded to right base frame beam 204a. Left nose truss 202b is welded to left base frame beam 204b. Center nose truss 202c is welded to right base frame beam 204a and left base frame beam 204b. Nose frame cross member 202d is welded between right nose truss 202a and left nose truss 202b. Nose rail 202e is welded to each of right nose truss 202a, left nose truss 202b and center nose truss 202c. Right side frame assembly 206 including a right side forward spar 206a, a right side aftward spar 206b, a right side upper beam 206c, a right side joint 206d, a lateral flange 206e and right side plate member 16a. Right side joint 206d is welded to nose rail 202e, right side forward spar 206a is welded between right side joint 206d and steering column mount 210, right side aftward spar 206b is welded to steering column mount 210, right side upper beam 206c is welded between right side joint 206d and right side aftward spar 206b, lateral flange 206e is welded to right side forward spar 206a and right side plate member 16a is welded to right side aftward spar 206b, right side upper beam 206c and right base frame beam 204a.

The fixed portion of left side frame assembly 208 includes a left side aftward spar 208b, a left side joint 208d and left side plate member 16b. Left side joint 208d is welded to nose rail 202e, left side aft spar 208b is welded to steering column mount 210, and left side plate member 16b is welded to left side aft spar 208b and left base frame beam 204b. In the illustrated embodiment, the fixed portion of left side frame assembly 208 includes a top flange 208f that is welded to or integral with steering column mount 210, an upper flange 208g and an aft flange 208h that are welded to or integral with left side joint 208d and an upper flange 208i that is welded to or integral with left side plate member 16b. As discussed herein, the fixed portion of left side frame assembly 208 includes an engine installation window 208e that is disposed between left side joint 208d, left side aftward spar 208b and left side plate member 16b. A lower forward cross member 210a is welded between right side joint 206d and left side joint 208d. In this configuration, welded frame assembly 200 provides efficiency to the construction of snowmobile 10.

As best seen in the comparison of FIGS. 5A and 5B, prior to installing engine 26 into welded frame assembly 200, arcuate heat exchanger 104 is coupled to welded frame assembly 200 using rivets or other suitable connection means by coupling the side panels of arcuate heat exchanger 104 to right side plate member 16a and left side plate member 16b of welded frame assembly. Arcuate heat exchanger 104 has an arcuate inner surface 104a which has a substantially constant radius of curvature 104b and an arcuate outer wall 104c which has a substantially constant radius of curvature 104d. Radii of curvature 104b, 104d share a common center of curvature 104e that is coincident with an axis of rotation 44a of track driveshaft 44 (see also FIG. 2C). The configuration of arcuate heat exchanger 104 not only improves its snow receiving and retention functionality but also minimizes the space requirements of arcuate heat exchanger 104, thereby enlarging engine bay 26a which is substantially defined within the subassembly of arcuate heat exchanger 104 and welded frame assembly 200. In fact, the curvature of arcuate heat exchanger 104 allows for the preassembly of an aft portion of fluid conduit 112 that fluidically couples radiator 110 to arcuate heat exchanger 104. In addition, right mounting bracket 212a and left mounting bracket 212b may be welded to outer wall 104c of arcuate heat exchanger 104.

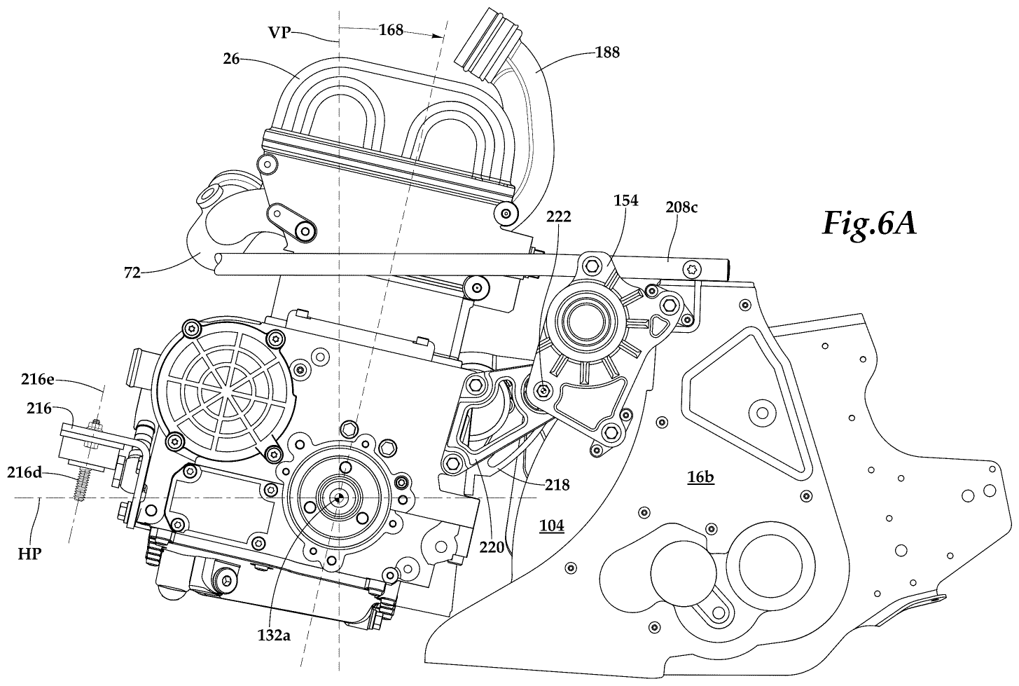

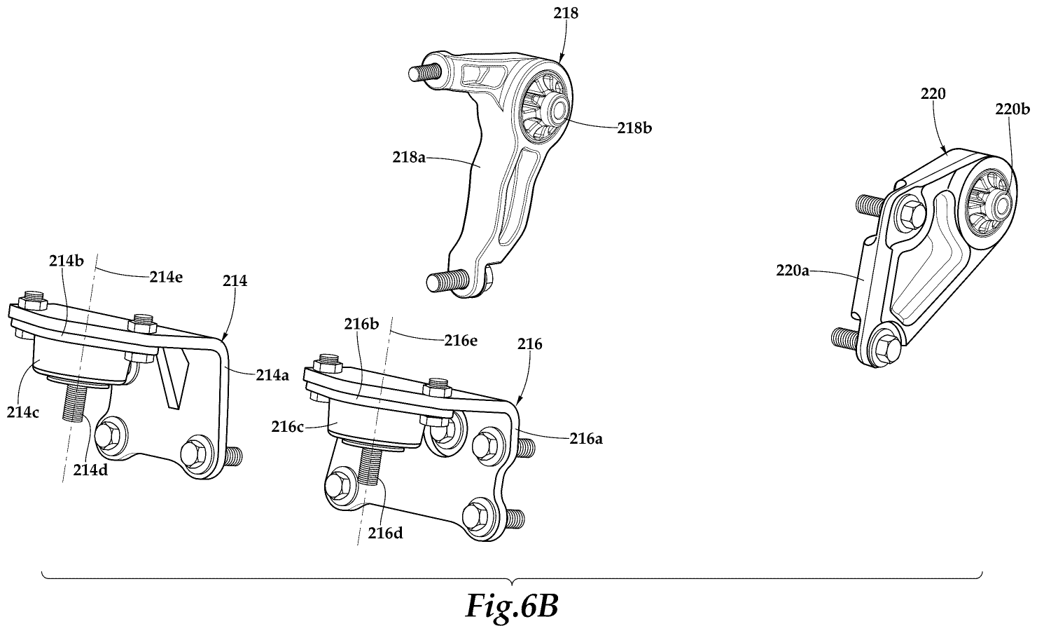

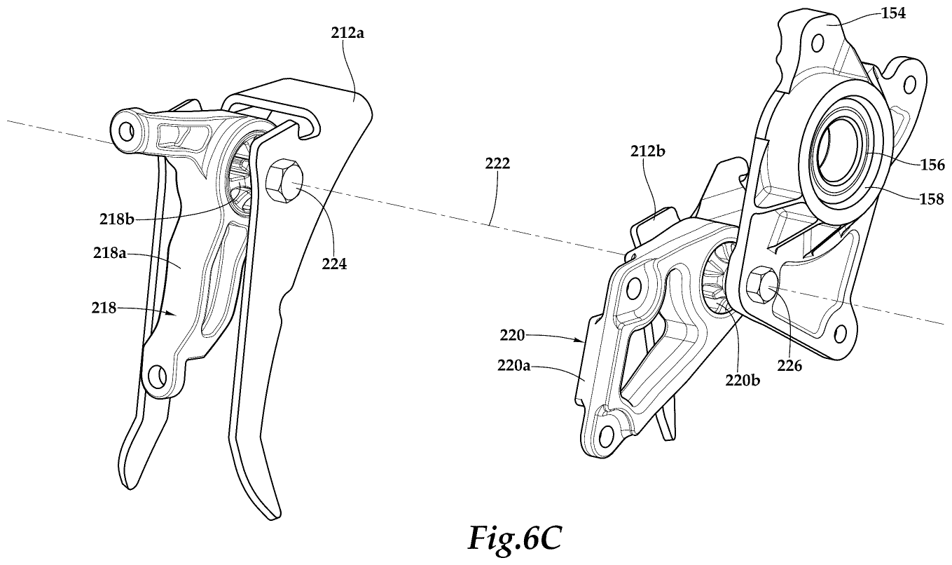

Once heat exchanger 104 has been coupled to welded frame assembly 200, engine 26 may now be positioned within engine bay 26a as best seen in the progression of FIGS. 5C-5D. In FIG. 5C, an engine preassembly preferably includes engine 26 with exhaust manifold 72 and air runner assembly 188 installed thereon. Also, preinstalled on engine 26 is an engine mounting system that includes a right forward engine mount 214, a left forward engine mount 216, a right aftward engine mount 218 and a left aftward engine mount 220 (see also FIGS. 3A-3G and 6B). In other embodiments, one or more of right forward engine mount 214, left forward engine mount 216, right aftward engine mount 218 and left aftward engine mount 220 may be coupled to engine 26 after engine 26 has been positioned within welded frame assembly 200. In such embodiments, all or a portion of right forward engine mount 214 and/or left forward engine mount 216 may be coupled to nose frame cross member 202d prior to being coupled to engine 26. Likewise, all or a portion of right aftward engine mount 218 and/or left aftward engine mount 220 may be coupled to heat exchanger 104 and/or welded frame assembly 200 prior to being coupled to engine 26. In the illustrated embodiments, right forward engine mount 214 includes an angled bracket 214a that is bolted to a forward side of engine 26, a mounting flange 214b that is bolted to angled bracket 214a, a vibration damper 214c that is coupled to mounting flange 214b and a mounting stud 214d having a mount axis 214e. Left forward engine mount 216 includes an angled bracket 216a that is bolted to engine 26, a mounting flange 216b that is bolted to angled bracket 216a, a vibration damper 216c that is coupled to mounting flange 216b and a mounting stud 216d having a mount axis 216e. Right aftward engine mount 218 has a body 218a that is bolted to an aftward side of engine 26 and a vibration damper 218b that is received within an aperture of body 218a. Left aftward engine mount 220 has a body 220a that is bolted to the right side of engine 26 and a vibration damper 220b that is received within an aperture of body 220a. Right aftward engine mount 218 and left aftward engine mount 220 share a common mount axis 222 when right aftward engine mount 218 is coupled to right mounting bracket 212a via bolt 224 and left aftward engine mount 220 is coupled to left mounting bracket 212b and driven shaft bearing hub 154 via bolt 226, as best seen in FIG. 6C.

As best seen in FIG. 5C, engine 26 is laterally inserted into welded frame assembly 200 through window 208e of the fixed portion of left side frame assembly 208 as indicated by the laterally extending portion of engine installation path arrow 228 that originates at the tip of mounting stud 214d and serves as a reference. Engine 26 is positioned to provide suitable clearance between right forward engine mount 214 and left forward engine mount 216 with forward components of welded frame assembly 200 and to provide suitable clearance between right aftward engine mount 218 and left aftward engine mount 220 with fluid conduit 112, right mounting bracket 212a and left mounting bracket 212b. Once engine 26 is disposed within welded frame assembly 200, engine 26 is shifted forward to vertically align mounting stud 214d with mounting hole 202f of nose frame cross member 202d and to vertically align mounting stud 216d with mounting hole 202g of nose frame cross member 202d, as indicated by the forwardly extending portion of engine installation path arrow 228. Engine 26 is now lowered to insert mounting stud 214d into mounting hole 202f of nose frame cross member 202d and to insert mounting stud 216d into mounting hole 202g of nose frame cross member 202d, as indicated by the downwardly extending portion of engine installation path arrow 228. This lowering of engine 26 also aligns right aftward engine mount 218 with right mounting bracket 212a and left aftward engine mount 220 with left mounting bracket 212b.

Engine 26 is now secured to welded frame assembly 200 and heat exchanger 104 at three points; namely, nut 230a secures right forward engine mount 214 to nose frame cross member 202d, nut 230b secures left forward engine mount 216 to nose frame cross member 202d and bolt assembly 224 secures right aftward engine mount 218 to right mounting bracket 212a (see also FIG. 6C). Left aftward engine mount 220 may remain unsecured from left mounting bracket 212b until a later stage of assembly or left aftward engine mount 220 may be temporarily secured to left mounting bracket 212b. In this position within engine bay 26a, engine 26 is suspended above base frame assembly 204 with suitable clearance therewith such as between 10 millimeters and 50 millimeters or about 30 millimeters between a lower surface of engine 26 and an upper surface of base frame assembly 204. In other embodiments, engine 26 could be suspended above base frame assembly 204 by less than 10 millimeters or more than 50 millimeters.

With engine 26 positioned within engine by 26a and suspended above base frame assembly 204, non-preinstalled components of air intake system 176 may now be assembled onto engine 26. As best seen in FIG. 5E, air plenum 182 is positioned on top of engine 26 with throttle valve assembly 186 preinstalled therewith or subsequently coupled thereto. As discussed herein, air plenum 182 is coupled to air runner assembly 188 such that air inlet ports 188d, 188e, 188f of air runner assembly 188 are aligned with air discharge ports 182a, 182b, 182c of air plenum 182. In this orientation, throttle valve assembly 186 is positioned laterally outboard of engine 26 and laterally outboard of forward frame assembly 14 (see also FIG. 1D). With air plenum 182 and throttle valve assembly 186 in place, addition frame members can now be installed on welded frame assembly 200. Specifically, the separable portion of left side frame assembly 208 can be installed to the fixed portion of the left side frame assembly 208 with non-permanent fasteners.

As best seen in FIG. 4F, the separable portion of the left side frame assembly 208 includes a left side forward spar 208a that is coupled between top flange 208f and upper flange 208g with non-permanent fasteners depicted as bolts. In the illustrated embodiments, an upper cross member 210b is welded to left side forward spar 208a and is now coupled to lateral flange 206e with a non-permanent fastener depicted as a bolt. As best seen in FIG. 4G, the separable portion of the left side frame assembly 208 also includes a left side upper beam 208c that is coupled between aft flange 208h of left side joint 208d and upper flange 208i of plate member 16b with non-permanent fasteners depicted as bolts. With the installation of left side forward spar 208a, upper cross member 210b and left side upper beam 208c, the assembly for forward frame assembly 14 is complete. It should be noted that the use of left side frame assembly 208 having the separable portion not only enables engine installation through window 208e but also enhances engine servicing by providing improved access to engine 26 by removing one or more of the separable frame parts. In addition, it should be noted that right side forward spar 206a and left side forward spar 208a of forward frame assembly 14 are bent spars and more particularly are bent in the forward direction to provide additional space for engine 26 and other snowmobile components within forward frame assembly 14.

In addition, FIG. 5G depicts the installation of bearing hub 154 to the left outboard side of chassis 12. More particularly bearing hub 154 is coupled to left side upper beam 208c of forward frame assembly 14 via a fastener depicted as a bolt, coupled to left side plate member 16b via a fastener depicted as a bolt and coupled to left side end cap of heat exchanger 104 via a fastener depicted as a bolt. Bearing hub 154 is also coupled to aft mounting bracket 212b via a fastener depicted as bolt 226 that has mount axis 222 (see also FIG. 6C). Left aftward engine mount 220 is partially disposed between bracket 212b and bearing hub 154 such that bolt 226 resiliently supports left aftward engine mount 220 therebetween. In the illustrated embodiment, left aftward engine mount 220 and bracket 212b are positioned between longitudinal centerline 10a of snowmobile 10 and bearing hub 154. Once left aftward engine mount 220 is secured, engine 26 now has four points of support resiliently provided by right forward engine mount 214, left forward engine mount 216, right aftward engine mount 218 and left aftward engine mount 220. It is noted that the installation of bearing hub 154 may be delayed until installation of drivetrain 28 but is being shown here for the purposes of fully disclosing the mounting of engine 26.

As best seen in FIG. 5H, additional components of air intake system 176 have been installed. Specifically, airbox 180 has been coupled to forward frame assembly 14 and air duct 184 has been coupled between airbox 180 and throttle valve assembly 186. In this configuration, air inlet 178 that is positioned outboard of forward frame assembly 14, outboard of the engine bay 26a and above throttle valve assembly 186. Airbox 180 is positioned generally forward and generally above engine 26 and at least partially forward of the engine bay 26a. Air duct 184 is routed forward and outboard of left side forward spar 208a. This generally completes the assembly of air intake system 176 on engine 26. It should be understood by those having ordinary skill in the art that even though specific preassemblies of snowmobile systems have been depicted and described, and even though a particular order of installation has been depicted and described, other preassemblies and other installation orders are made possible with the use of welded frame assembly 200.

For example, as best seen in FIG. 5I, an engine preassembly includes engine 26 with exhaust manifold 72, air runner assembly 188 (not visible) and air plenum 182 together with throttle valve assembly 186 installed thereon. Also, preinstalled on engine 26 is a portion of the engine mounting system that includes right forward engine mount 214, left forward engine mount 216 and right aftward engine mount 218 (not visible). Compared to the engine preassembly of FIG. 5C, the present engine preassembly includes air plenum 182 and throttle valve assembly 186 but excludes left aftward engine mount 220. As before, engine 26 is laterally inserted into welded frame assembly 200 through window 208e of the fixed portion of left side frame assembly 208 as indicated by the laterally extending portion of engine installation path arrow 228 that originates at the tip of mounting stud 214d. Once engine 26 is disposed within welded frame assembly 200, engine 26 is shifted forward to vertically align mounting stud 214d with mounting hole 202f of nose frame cross member 202d and to vertically align mounting stud 216d with mounting hole 202g of nose frame cross member 202d, as indicated by the forwardly extending portion of engine installation path arrow 228. Engine 26 is now lowered to insert mounting stud 214d into mounting hole 202f of nose frame cross member 202d and to insert mounting stud 216d into mounting hole 202g of nose frame cross member 202d, as indicated by the downwardly extending portion of engine installation path arrow 228. This lowering of engine 26 also aligns right aftward engine mount 218 with right mounting bracket 212a. Engine 26 may now be secured to welded frame assembly 200 and heat exchanger 104 at three points; namely, nut 230a secures right forward engine mount 214 to nose frame cross member 202d, nut 230b secures left forward engine mount 216 to nose frame cross member 202d and bolt assembly 224 secures right aftward engine mount 218 to right mounting bracket 212a. The remaining components of forward frame assembly 14 and air intake system 176 may now be installed in a manner similar to that described above with reference to FIGS. 5F-5H with the added step of installing left aftward engine mount 220 to the left side of engine 26.

Referring additionally to FIGS. 6A-6C in the drawings, additional details regarding an engine mounting system will now be described. Right mounting bracket 212a and left mounting bracket 212b are welded to the forward face of arcuate heat exchanger 104 (see also FIG. 5B). Right mounting bracket 212a forms a clevis sized to receive right aftward engine mount 218 therein. Right aftward engine mount 218 includes vibration damper 218b that is received within an aperture of body 218a. Bolt 224 is used to resiliently secure right aftward engine mount 218 within right mounting bracket 212a such that mount axis 222 of bolt 224 extends substantially horizontally through the center of vibration damper 218b in the lateral direction. Bearing hub 154 and left mounting bracket 212b are positioned to form gap therebetween that is sized to receive left aftward engine mount 220 therein. Left aftward engine mount 220 includes vibration damper 220b that is received within an aperture of body 220a. Bolt 226 is used to resiliently secure left aftward engine mount 220 between bearing hub 154 and left mounting bracket 212b such that mount axis 222 of bolt 226, which is common to bolt 224, extends substantially horizontally through the center of vibration damper 220b in the lateral direction. Due to the resilient nature of vibration dampers 218b, 220b, vibration transfer from engine 26 to heat exchanger 102, bearing hub 154 and thus to driven shaft 128 is reduced and/or eliminated.

Nose frame assembly 202 including nose frame cross member 202d having openings 202f, 202g (see also FIG. 5C). Right forward engine mount 214 includes vibration damper 214c and mounting stud 214d used to resiliently secure right forward engine mount 214 to nose frame cross member 202d such that mount axis 214e of mounting stud 214d extends in a direction that is substantially parallel to aftward tilt angle 168 of engine 26. Likewise, left forward engine mount 216 includes vibration damper 216c and mounting stud 216d used to resiliently secure left forward engine mount 216 to nose frame cross member 202d such that mount axis 216e of mounting stud 216d extends in a direction that is substantially parallel to aftward tilt angle 168 of engine 26. Due to the resilient nature of vibration dampers 214c, 216c, vibration transfer from engine 26 to forward frame assembly 14 is reduced and/or eliminated. In this configuration, mount axes 214e, 216e of forward engine mounts 214, 216 are substantially normal to mount axis 222 of aftward engine mounts 218, 220. Also, in this configuration, aftward engine mounts 218, 220 are positioned outboard and above forward engine mounts 214, 216. In addition, forward engine mounts 214, 216 and aftward engine mounts 218, 220 are positioned above a horizontal plane HP including crankshaft 132.

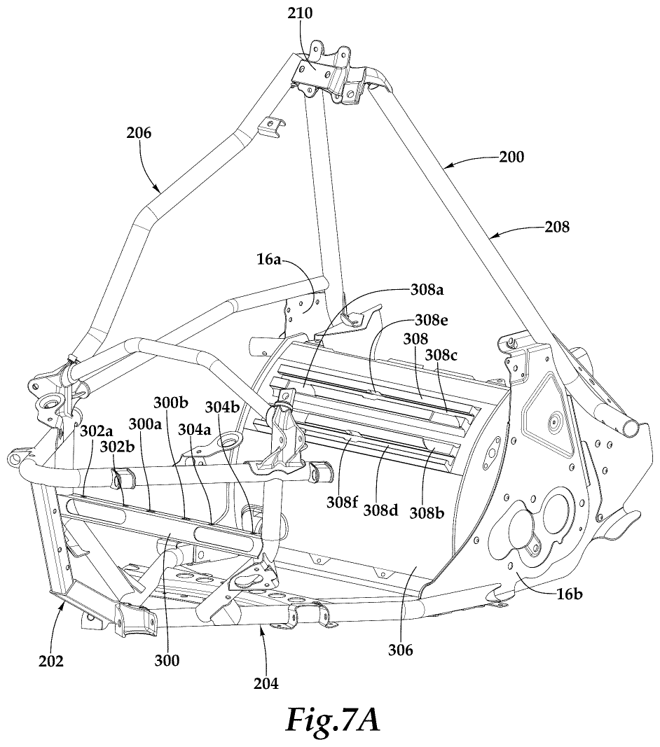

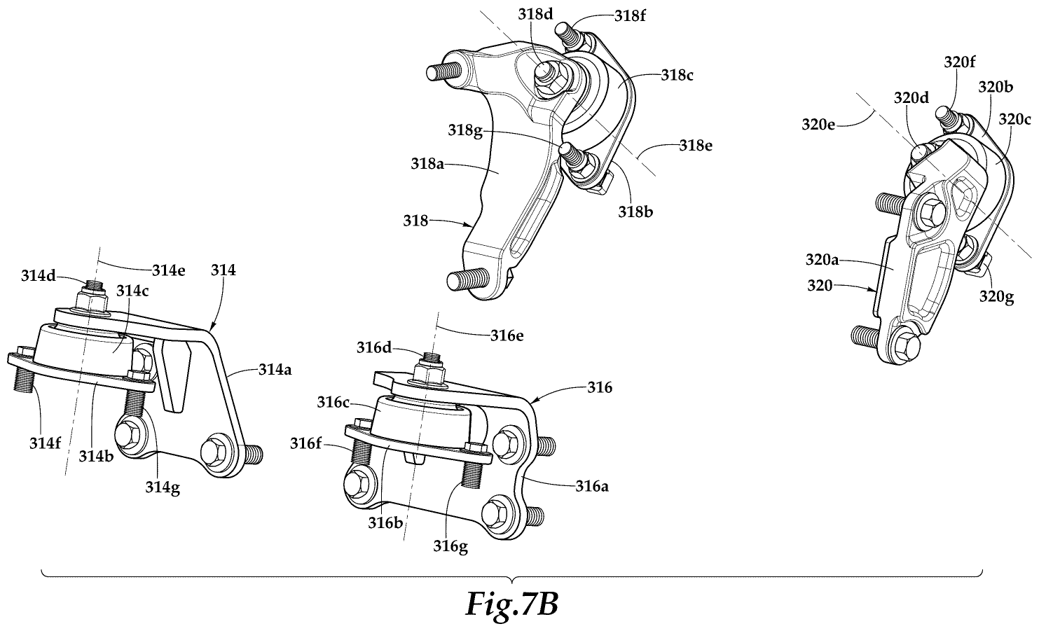

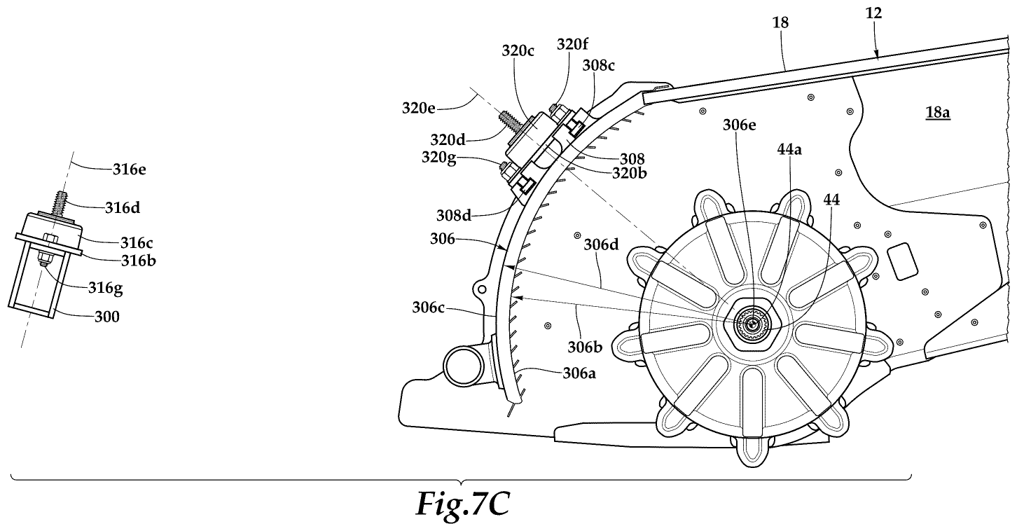

Referring next to FIGS. 7A-7C of the drawings, a second embodiment of an engine mounting system will now be discussed. In FIG. 7A, welded frame assembly 200 includes nose frame assembly 202, a base frame assembly 204, a right side frame assembly 206 and a fixed portion of a left side frame assembly 208 as well as a steering column mount 210. Each of the frame assemblies remains the same as discussed herein except that nose frame assembly 202 includes a modified nose frame cross member 300 that is designed for mounting a plurality of snowmobile components thereto. For example, nose frame cross member 300 includes a pair of central openings 300a, 300b for receiving bolts therethrough that are configured for coupling a snowmobile component to nose frame cross member 300 in between the right and left forward engine mounts such as the electronic steering assist unit that is coupled to the nose frame cross member of the forward frame assembly described in commonly owned U.S. patent application Ser. No. 18/669,805, filed May 21, 2024, the entire contents of which are incorporated by reference herein for all purposes. In addition, nose frame cross member 300 includes a pair of right openings 302a, 302b and a pair of left openings 304a, 304b for receiving bolts therethrough for coupling the right and left forward engine mounts to nose frame cross member 300.

An arcuate heat exchanger 306 is coupled to tunnel 18 and welded frame assembly 200 using rivets or other suitable connection means including by coupling the end caps of arcuate heat exchanger 306 to right side plate member 16a and left side plate member 16b of welded frame assembly 200. Arcuate heat exchanger 306 has an arcuate inner surface 306a which has a substantially constant radius of curvature 306b and an arcuate outer wall 306c which has a substantially constant radius of curvature 306d. Radii of curvature 306b, 306d share a common center of curvature 306e that is coincident with axis of rotation 44a of track driveshaft 44. Arcuate heat exchanger 306 includes a mounting system depicted as mounting rails 308 that are preferably formed integrally with outer wall 306c using, for example, an extrusion process followed by a machining process and thus does not require welding of non-integral brackets to the forward side of outer wall 306c. Mounting rails 308 include a right recessed mounting location 308a and a left recessed mounting location 308b that may be machined into mounting rails 308 to receive the right and left aftward engine mounts therein. Mounting rails 308 also include upper and lower slots 308c, 308d sized to receive and secure bolt heads therein such that the right and left aftward engine mounts can be coupled thereto.

The present engine mounting system includes a right forward engine mount 314, a left forward engine mount 316, a right aftward engine mount 318 and a left aftward engine mount 320. In the illustrated embodiments, right forward engine mount 314 includes an angled bracket 314a that is bolted to a forward side of engine 26. A mounting flange 314b and a vibration damper 314c are secured to angled bracket 314a with a bolt 314d along mounting axis 314e. Mounting flange 314b is coupled to nose frame cross member 300 with bolts 314f, 314g that extend through right openings 302a, 302b to resiliently secure right forward engine mount 314 to nose frame cross member 300 such that mount axis 314e extends in a direction that is substantially parallel to aftward tilt angle 168 of engine 26 (see also FIG. 3F). More specifically, to install right forward engine mount 314 to nose frame cross member 300, mounting flange 314b and vibration damper 314c are positioned relative to nose frame cross member 300 and coupled thereto with bolts 314f, 314g. Angled bracket 314a may be preinstalled on engine 26 and coupled to mounting flange 314b and vibration damper 314c upon positioning of engine 26 within welded frame assembly 200.

Left forward engine mount 316 includes an angled bracket 316a that is bolted to a forward side of engine 26. A mounting flange 316b and a vibration damper 316c are secured angled bracket 316a with a bolt 316d along mounting axis 316e. Mounting flange 316b is coupled to nose frame cross member 300 with bolts 316f, 316g that extend through left openings 304a, 304b to resiliently secure left forward engine mount 316 to nose frame cross member 300 such that mount axis 316e extends in a direction that is substantially parallel to aftward tilt angle 168 of engine 26, as best seen in FIG. 7C. More specifically, to install left forward engine mount 316 to nose frame cross member 300, mounting flange 316b and vibration damper 316c are positioned relative to nose frame cross member 300 and coupled thereto with bolts 316f, 316g. Angled bracket 316a may be preinstalled on engine 26 and coupled to mounting flange 316b and vibration damper 316c upon positioning of engine 26 within welded frame assembly 200. Due to the resilient nature of vibration dampers 314c, 316c, vibration transfer from engine 26 to nose frame cross member 300 and thus to welded frame assembly 200 is reduced and/or eliminated. It is noted that the bolt openings in angled bracket 314a, 316a may be oversized to allow certain tolerance during engine installation such that bolts 314d, 316d may pass therethrough even when there is slight misalignment of engine 26 relative thereto and to allow for proper alignment of engine 26 in the longitudinal direction.

Right aftward engine mount 318 has a body 318a that is bolted to an aftward side of engine 26. A mounting flange 318b and a vibration damper 318c are secured to body 318a with a bolt 318d along mounting axis 318e. Mounting flange 318b is coupled to mounting rails 308 with bolts 318f, 318g. More specifically, to install right aftward engine mount 318 to mounting rails 308, mounting flange 318b and vibration damper 318c are positioned relative to mounting rails 308 such that the head of bolt 318f is received within a central opening 308e of upper slot 308c and the head of bolt 318g is received within a central opening 308f of lower slot 308d. Mounting flange 318b and vibration damper 318c are then moved toward and properly aligned with right recessed mounting location 308a such that mounting flange 318b can be received within right recessed mounting location 308a. Thereafter, bolts 318f, 318g are tightened to secure mounting flange 318b and vibration damper 318c in place within right recessed mounting location 308a. Body 318a may be preinstalled on engine 26 and coupled to mounting flange 318b and vibration damper 318c upon positioning of engine 26 within welded frame assembly 200.

Left aftward engine mount 320 has a body 320a that is bolted to features on an aftward side of engine 26. A mounting flange 320b and a vibration damper 320c are secured to body 320a with a bolt 320d along mounting axis 320e. Mounting flange 320b is coupled to mounting rails 308 with bolts 320f, 320g. More specifically, to install left aftward engine mount 320 to mounting rails 308, mounting flange 320b and vibration damper 320c are positioned relative to mounting rails 308 such that the head of bolt 320f is received within central opening 308e of upper slot 308c and the head of bolt 320g is received within central opening 308f of lower slot 308d. Mounting flange 320b and vibration damper 320c are then moved toward and properly aligned with left recessed mounting location 308b such that mounting flange 320b can be received within left recessed mounting location 308b. Thereafter, bolts 320f, 320g are tightened to secure mounting flange 320b and vibration damper 320c in place within left recessed mounting location 308b. Body 320a may be preinstalled on engine 26 and coupled to mounting flange 320b and vibration damper 320c upon positioning of engine 26 within welded frame assembly 200.

As best seen in FIG. 7C, once mounting flange 320b is secured to mounting rails 308 within left recessed mounting location 308b and with bolts 320f, 320g, mount axis 320e extends through heat exchanger 306 in a radial direction relative to axis of rotation 44a of track driveshaft 44. Likewise, when mounting flange 318b is secured to mounting rails 308 within right recessed mounting location 308a and with bolts 318f, 318g, mount axis 318e extends through heat exchanger 306 in a radial direction relative to axis of rotation 44a of track driveshaft 44. In the illustrated embodiment, the recessed shapes of mounting locations 308a, 308b conform to the shapes of mounting flanges 318b, 320b such that mounting flanges 318b, 320b properly locate therein during fastening of mounting flanges 318b, 320b to mounting rails 308, installation of engine 26 and operation of aftward engine mounts 318, 320. In addition, mounting locations 308a, 308b together with mounting flanges 318b, 320b provide positive mounting locations to ensure proper alignment of engine 26 in the lateral direction within welded frame assembly 200. It is noted that the bolt openings in bodies 318a, 320a may be oversized to allow certain tolerance during engine installation such that bolts 318d, 320d may pass therethrough even when there is slight misalignment of engine 26 relative thereto.

Due to the resilient nature of vibration dampers 318c, 320c, vibration transfer from engine 26 to heat exchanger 306 is reduced and/or eliminated. Mounting rails 308 extend the lateral direction of snowmobile 10 and have a length that is more than half the lateral length of heat exchanger 306 and, in the illustrated embodiment, have a length of about ninety percent of the lateral length of heat exchanger 306. As such, mounting rails 308 enhance the structure of heat exchanger 306 thus providing a more robust support for engine 26. In addition, heat exchanger 306 may include internal reinforcement elements to provide added support for engine 26 such as those positioned in the heat exchanger disclosed in commonly owned U.S. patent application Ser. No. 18/666,651, filed May 16, 2024, the entire contents of which are incorporated by reference herein for all purposes.

Even though mounting rails 308 have been depicted as described as having mounting location for mounting flanges 318b, 320b, it should be understood by those having ordinary skill in the art that mounting rails 308 could be used for mounting other or additional snowmobile components thereto including, for example, a bearing hub, such as bearing hub 154 discussed herein, a gearbox assembly associated with driven shaft 138 or another desired component. Also, even though each of vibration dampers 314c, 316c, 318c, 320c has been depicted to include a threaded stud 314d, 316d, 318d, 320d respectively extending outwardly therefrom and configured to extend through a bolt opening in a respective one of bodies 314a, 316a, 318a, 320a and receive a nut, it should be understood by those having ordinary skill in the art that bodies 314a, 316a, 318a, 320a may be coupled to vibration dampers 314c, 316c, 318c, 320c using bolts that extend through the bolt openings in bodies 314a, 316a, 318a, 320a and into vibration dampers 314c, 316c, 318c, 320c. In addition, even though the bolts that couple mounting flanges 318b, 320b to mounting rails 308, such as bolt 320g, have been depicted as having square heads, it should be understood by those having ordinary skill in the art that these bolts could have heads with other shapes and/or these bolts could be used in conjunction with washers to couple mounting flanges 318b, 320b to mounting rails 308.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. For example, numerous combinations of the features disclosed herein will be apparent to persons skilled in the art including the combining of features described in different and diverse embodiments, implementations, contexts, applications and/or figures. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. A snowmobile comprising:
a forward frame assembly defining an engine bay;
an engine positioned within the engine bay, the engine having a plurality of intake ports positioned on an aft side of the engine and a plurality of exhaust ports positioned on a forward side of the engine;
an air intake system having at least one air inlet and a plurality of air outlets, the air intake system coupled to the aft side of the engine such that each of the air outlets is configured to provide air to one of the intake ports; and
an exhaust system having a plurality of exhaust inlets and at least one exhaust outlet, the exhaust system coupled to the forward side of the engine such that each of the exhaust inlets is configured to receive exhaust from one of the exhaust ports.

2. The snowmobile as recited in claim 1 wherein, the engine is a four-stroke engine.

3. The snowmobile as recited in claim 1 wherein, the air intake system further comprises an airbox positioned at least partially forward of the engine bay, the airbox includes the at least one air inlet; and
wherein, the at least one air inlet is positioned outboard of the engine bay.

4. The snowmobile as recited in claim 3 wherein, the air intake system further comprises an air plenum positioned on top of the engine.

5. The snowmobile as recited in claim 4 wherein, the air plenum is positioned at least partially within the engine bay.

6. The snowmobile as recited in claim 4 wherein, the air intake system further comprises a throttle valve assembly coupled to the air plenum, the throttle valve assembly positioned outboard of the engine bay.

7. The snowmobile as recited in claim 6 wherein, the throttle valve assembly is positioned below the at least one air inlet.

8. The snowmobile as recited in claim 6 wherein, the air intake system further comprises an air duct coupled between the airbox and the throttle valve assembly, the air duct routed forward and outboard of the forward frame assembly.

9. The snowmobile as recited in claim 6 wherein, the air intake system further comprises an air runner assembly coupled between the air plenum and the aft side of the engine, the air runner assembly includes the plurality of air outlets; and
wherein, the air runner assembly extends aftward and downward from the air plenum.

10. The snowmobile as recited in claim 1 wherein, the exhaust system further comprises an exhaust manifold coupled to the forward side of the engine, the exhaust manifold includes the exhaust inlets.

11. The snowmobile as recited in claim 10 wherein, the exhaust system further comprises a muffler positioned outboard of the engine bay.

12. The snowmobile as recited in claim 1 wherein, the air intake system further comprises a throttle valve assembly positioned outboard of the engine bay on a first side of the engine; and
wherein, the exhaust system further comprises a muffler positioned outboard of the engine bay on a second side of the engine that is opposite the first side of the engine.

13. A snowmobile comprising:
a forward frame assembly defining an engine bay;
an engine positioned within the engine bay, the engine having a plurality of intake ports positioned on an aft side of the engine and a plurality of exhaust ports positioned on a forward side of the engine;
an air intake system coupled to the aft side of the engine, the air intake system includes an airbox having an air inlet that is positioned outboard of the engine bay, an air plenum positioned on top of the engine, a throttle valve assembly coupled between the airbox and the air plenum, the throttle valve assembly positioned outboard of the engine bay on a first side of the engine and an air runner assembly coupled between the air plenum and the engine, the air runner assembly including a plurality of air outlets each of which is configured to provide air to one of the intake ports; and
an exhaust system coupled to the forward side of the engine, the exhaust system including an exhaust manifold having a plurality of exhaust inlets each of which is configured to receive exhaust from one of the exhaust ports and a muffler including an exhaust outlet positioned outboard of the engine bay on a second side of the engine that is opposite of the first side;
wherein, each of the engine, the air plenum, the air runner assembly and the exhaust manifold is at least partially disposed within the engine bay.

14. The snowmobile as recited in claim 13 wherein, the throttle valve assembly is positioned below the air inlet.

15. The snowmobile as recited in claim 13 wherein, the air runner assembly extends aftward and downward from the air plenum.

16. The snowmobile as recited in claim 13 wherein, the engine is tilted aftward such that an upper portion of the engine is aft of a lower portion of the engine.

17. The snowmobile as recited in claim 13 further comprising a heat exchanger coupled to the forward frame assembly forward of the engine.

18. The snowmobile as recited in claim 17 wherein, the heat exchanger is tilted forward such that an upper portion of the heat exchanger is forward of a lower portion of the heat exchanger.

19. The snowmobile as recited in claim 17 wherein, at least a portion of the exhaust manifold is positioned between the heat exchanger and the engine.

20. The snowmobile as recited in claim 17 wherein, the muffler is positioned aft of the heat exchanger.
